(19) United States
(12) Patent Application Publication
(10) Pub. No.: US 2011/0183651 A1
(43) Pub. Date: Jul. 28, 2011

(54) System and method for requesting, retrieving and/or associating contact images on a mobile device

(75) Inventors: L. Starlight Mundy, San Diego, CA (US); Ralph Neff, San Diego, CA (US); Osama Al-Shaykh, San Diego, CA (US); Sanae Hotani, San Diego, CA (US)

(73) Assignee: PacketVideo Corp.

(21) Appl. No.: 12/657,802

(22) Filed: Jan. 28, 2010

(51) Int. Cl. H04W 4/00; G06F 17/30

(52) U.S. Cl. 455/414.1; 707/722; 707/E17.014

(57) ABSTRACT

A system and a method request, retrieve and/or associate contact images on a mobile device. An image retrieval application executed by a first mobile device may enable a first user to request images corresponding to one or more contact entries stored by a contact database of the first mobile device and/or associated with second users. The image retrieval application may query one or more image databases accessible to the first mobile device to obtain a first image and/or to associate the first image with a corresponding contact entry in the contact database of the first mobile device. If the image databases do not provide the first image requested by the image retrieval application, the image retrieval application may create and/or may send a request message to the second user, such as, for example, by sending the request message to a second mobile device associated with the second user.

### BACKGROUND OF THE INVENTION

The present invention generally relates to a system and a method for requesting, retrieving and/or associating contact images on a mobile device. More specifically, the present invention relates to an image retrieval application executed by a first mobile device. The image retrieval application may enable a user of the first mobile device to request images corresponding to remote contacts associated with contact entries stored by a contact database of the first mobile device. The image retrieval application may request a first image from one or more image databases accessible to the first mobile device, and/or the image retrieval application may associate the first image with the first contact entry in the contact database of the first mobile device. If the image databases do not provide the first image requested by the image retrieval application, the image retrieval application may create and/or may send a request message, such as, for example, by sending the request message to a second mobile device associated with the first contact entry.

Capabilities of typical mobile devices have increased significantly. Currently, many inexpensive mobile devices are equipped with high resolution color screens, fast microprocessors, high quality image and/or video cameras, and access to a large amount of memory. The memory may use fixed internal memory; removable memory, such as, for example, a removable memory card; or a combination of fixed internal memory and removable memory.

Sophisticated hardware capabilities of the mobile device are utilized by increasingly sophisticated software applications. In the past, users expected and enjoyed various basic software applications. For example, it is well known for a contacts application to create a contacts database containing names and phone numbers of contacts and use the contacts database to place calls to contacts listed therein. More recently, mobile device software applications allow users to capture images and/or videos from the camera on the mobile device; send and receive messages containing images and/or other multimedia objects; access the internet using a browser application on the mobile device; and browse, retrieve and/or play multimedia files in a multimedia player application. These mobile device software applications extensively use images and other multimedia objects. The user interface presented and used by these mobile device software applications has also evolved to utilize graphics and animation.

It is well known that a mobile device may allow the user to associate images with contact entries in the contacts database of the mobile device. Typically, association of the images with the contact entries is performed using a contacts application installed on the mobile device by the provider of the mobile device. For example, the user may use the contacts application to find and/or select an existing entry in the contacts database and/or to create a new entry. The user may use the contacts application to browse images which may be stored in the memory accessible to the mobile device, and the user may select one of the images to be associated with a selected contact entry in the contacts database. The selected image may have been captured with the camera of the mobile device, such as, for example, in advance of the association with the selected contact entry or at the time the user associates the image with the selected contact entry.

The mobile device may use the images associated with contact entries for actions involving the contact entries. For example, the mobile device may display the image when calling the associated contact, when receiving a call from the associated contact, when receiving a message from the associated contact, when accessing and/or displaying the contact entry for the associated contact, and/or the like. Recent mobile telephones with rich graphical user interfaces may extensively use the images associated with the contact entries. For example, the HTC Diamond (trademark of HTC Corporation) mobile phone allows the user to place a call using a rotating graphic display of the images associated with the contact entries. Thus, the images associated with the contact entries may enhance enjoyment of the basic functions of the mobile device for the user and may utilize the basic functions of the mobile device in new ways.

However, mobile device users may not obtain the advantages provided by use of images associated with contact entries because acquiring the images and associating the images with the contact entries in the contacts database is typically burdensome. Image acquisition requires that the user individually acquire an image for each of the contact entries. The image acquisition for a specific contact may be accomplished by physically visiting the contact and capturing the image of the contact using the mobile device camera. This method may only be practical for a subset of the contacts, such as, for example, the contacts that reside in the same area as the user or the contacts that the user visits regularly. Alternatively, the image acquisition may be accomplished remotely by calling the contact, by sending a message to the contact, or by sending an email to the contact requesting that the contact provides the image. This method does not require a physical visit to the contact; however, the contact must provide the image by sending the image to the mobile device and/or the user of the mobile device. The user must manually generate request messages, and the user must manage response messages to collect the images which may be provided by the response messages. The user must store and organize the images in the memory of the mobile device.

In both methods of image acquisition, the user must subsequently take manual steps to associate the images with the contact entries in the contacts database using methods available on the mobile device and/or provided by the contacts application on the mobile device. The process by which the user associates the image with the contact entry in the contacts database may vary depending on the mobile device and the associated software application. However, the process is typically a manual process in that the user must manually select the contact entry and the image at the time the user establishes the association. Accordingly, image acquisition and subsequent association with contact entries may be difficult and burdensome to the user of the mobile device, and the user may not associate images with some of the contact entries in the contacts database.

In addition, image acquisition may burden the contacts who are requested and/or expected to provide the images to the user of the mobile device. A contact may receive multiple requests at different times from different users, and the contact must repeat similar steps for each request to provide the image to the user who sent the request. Thus, the contact cannot conveniently specify an image which may be retrieved and/or may be used by any user who desires to associate an image with the contact. Further, the contact may wish to specify and/or control the image which the contact provides to users based on the relationship between the contact and the users. For example, the contact may have a first image that the contact may provide to family members, a second image that the contact may provide to friends, a third image that the contact may provide to business contacts, and a fourth image that the contact may provide to the significant other of the contact. The contact may be unwilling to provide an image to specific users, classes of users, and/or to users that the contact does not recognize. To manually receive, parse and respond to requests for images from various users to provide the images to the appropriate users may be difficult and burdensome for the contact, especially if the users request the images from the contact at different times and with different types of request messages.

There are several approaches to create, modify and/or save contact entries in the contacts database of the mobile device. One approach is the exchange of contact information between mobile devices using Object Exchange (“OBEX”). For example, Object Exchange may use infrared communication according to specifications from the Infrared Data Association (“IrDa,” which is a trademark of the Infrared Data Association Corporation). Alternatively, the exchange may use radio communication technologies, such as, for example, Near Field Communications (“NFC”) or Bluetooth (trademark of Bluetooth SIG, Inc.). The contact information may have the name, one or more phone numbers and/or one or more email addresses of the contact. The contact information may have a photograph of the contact. The contact information may be exchanged as a vCard that may be formatted as a photograph entry. However, in this approach, the user and the contact must be positioned in the same physical location because the transmission distances are approximately 10 cm, 5 cm and 10 m for IrDA, NFC and Bluetooth, respectively.

Another approach is using email or Multimedia Messaging Service (“MMS”). A user of a mobile device may send the contact information to a remote contact by email or MMS. However, sending the contact information by email or MMS is a manual process which requires effort from the user of the mobile device to distribute the contact information to a large set of remote contacts. Further, the user of the mobile device must manually process any responses to the outgoing messages. For example, the user of the mobile device may receive a large number of messages from the remote contacts, and the messages from the remote contacts may not have the contact information and/or the photographs associated with the remote contacts. In this case, the user of the mobile device must manually read the messages and must manually associate the contact information and/or the photographs with corresponding contact entries in the contacts database of the mobile device.

In yet another approach, a Photo Phonebook application is an application available in the iTunes “App Store” (trademarks of Apple Inc.). The Photo Phonebook application determines which contact entries in an iPhone (trademark of Apple Inc.) contacts database correspond to individuals in a Facebook (trademark of Facebook, Inc.) friends list of the user of the iPhone. Then, the Photo Phonebook application downloads Facebook profile pictures of individuals in the Facebook friends list from Facebook to the iPhone contacts database. The Photo Phonebook application associates the downloaded Facebook profile pictures with the corresponding contact entries in the iPhone contacts database. Subsequently, if an incoming call to the iPhone is initiated by an individual associated with one of the contact entries in the iPhone contacts database which corresponds to a Facebook friend, the iPhone may display the Facebook profile picture of the caller. In addition, the iPhone contacts database may display the Facebook profile picture to identify the contact.

The Photo Phonebook application has disadvantages. First, the Photo Phonebook application requires that the user of the mobile device has a Facebook account. Second, the Photo Phonebook application is only capable of retrieving and associating photographs for the contact entries which match the Facebook friends list provided on the Facebook social networking webpage of the user of the mobile device. Photographs cannot be retrieved for contacts who do not use Facebook, who do not have Facebook accounts, who the user of the mobile device has not listed as a Facebook friend on Facebook, or who have not uploaded a profile picture to Facebook. Some contacts may not use Facebook or may not provide personal information, such as a personal photograph, on Facebook. Therefore, the Photo Phonebook application may only enable retrieval of photographs for a subset of the contact entries of the local user.

Therefore, the prior art offers methods for retrieving and associating images for contact entries. However, the prior art methods have limitations remedied by the present invention.

### SUMMARY OF THE INVENTION

The present invention generally relates to a system and a method for requesting, retrieving and/or associating contact images on a mobile device. More specifically, the present invention relates to an image retrieval application executed by a first mobile device. The image retrieval application may enable a user of the first mobile device to request images corresponding to remote contacts associated with contact entries stored by a contact database of the first mobile device. The image retrieval application may request a first image from one or more image databases accessible to the first mobile device, and/or the image retrieval application may associate the first image with the first contact entry in the contact database of the first mobile device. If the image databases do not provide the first image requested by the image retrieval application, the image retrieval application may create and/or may send a request message, such as, for example, by sending the request message to a second mobile device associated with the first contact entry. The request message may be based on a standard messaging format with extensions added to enable processing by the image retrieval application.

If the second mobile device has a compatible application, the compatible application of the second mobile device may automatically receive and/or respond to the request message. The response may provide the first image, such as, for example, a photograph previously specified by a first remote contact associated with the first contact entry for the compatible application to use in response to request messages. If the second mobile device does not have a compatible application, the request message may be interpreted as a standard messaging format which the first remote contact may receive, may view and/or may use for response. For example, the request message may be an SMS message, an MMS message, an email message and/or the like. The request message may provide human-readable instructions which may instruct the first remote contact to send a reply message to the request message and/or to attach the first image to the reply message.

To this end, in an embodiment of the present invention, a method for retrieving contact images for a user of a first mobile device having contact entries stored in an internal contacts database is provided. The method has the steps of accepting user input on the first mobile device wherein the user input identifies a first contact entry of the contact entries; determining if a photo database accessible to the first mobile device and remotely located relative to the first mobile device provides a first contact image corresponding to the first contact entry wherein the first mobile device determines if the photo database provides the first contact image; receiving the first image on the first mobile device from the photo database if the photo database provides the first contact image; associating the first contact image with the first contact entry in the internal contacts database if the first contact image is received from the photo database wherein the first mobile device automatically associates the first contact image with the first contact entry without input from the user directing the first mobile device to associate the first contact image with the first contact entry; and transmitting a first request message from the first mobile device to a second mobile device if the photo database does not provide the first contact image wherein the second mobile device is associated with the first contact entry.

In an embodiment, the method has the step of receiving a response message providing the first contact image from the second mobile device wherein the first mobile device automatically associates the first contact image provided by the response message with the first contact entry in the internal contacts database without input from the user directing the first mobile device to associate the first contact image with the first contact entry.

In an embodiment, the method has the step of transmitting a second request message to the second mobile device if a response to the first request message is not received during a predetermined time period.

In an embodiment, the method has the steps of identifying a second contact entry which is a different entry than the first contact entry based on the user input; and determining if the photo database provides a second contact image associated with the second contact entry which is a different image than the first contact image wherein the first mobile device determines if the photo database provides the first contact image and the second contact image substantially simultaneously.

In an embodiment, the method has the step of attaching a second contact image to the first request message wherein the second contact image is associated with the user of the first mobile device and further wherein the first mobile device sends the second contact image to the second mobile device with the first request message.

In an embodiment, the method has the step of receiving a response message providing the first contact image from the second mobile device wherein the response message has an identifier copied into the response message from the first request message wherein the first mobile device uses the identifier to determine that the response message corresponds to the first request message.

In another embodiment of the present invention, a system for exchanging contact images is provided. The system has a mobile device having contact entries stored in a contacts database of the mobile device wherein each of the contact entries is associated with a remote contact; an application executed by the mobile device; and a first request message from a first sender received by the mobile device wherein the application determines if the first sender corresponds to one of the contact entries and further wherein the application determines if the first request message provides a first contact image wherein the application automatically stores the first contact image in the mobile device in association with the one of the contact entries if the first sender corresponds to the one of the contact entries and the first request message provides the first contact image.

In an embodiment, the system has a response message automatically transmitted with a second contact image associated with a user of the mobile device if the first sender corresponds to one of the contact entries wherein the mobile device transmits the response message and the second contact image to the first sender without input from the user directing the mobile device to send the response message with the second contact image.

In an embodiment, the system has a response message with a second contact image associated with a user of the mobile device transmitted from the mobile device to the first sender wherein the user of the mobile device generates the response message using a messaging application executed by the mobile device and further wherein the response message has an identifier copied from the first request message.

In an embodiment, the system has a hyperlink in the first request message wherein selection of the hyperlink by a user of the mobile device provides a web page which enables the user of the mobile device to provide a second contact image associated with the user of the mobile device which is accessible to the first sender.

In an embodiment, the system has a subset of the contact entries specified by a user of the mobile device before receipt of the first request message wherein the application automatically directs the mobile device to send a response message to the first sender providing a second contact image associated with the user of the mobile device in response to the first request message if the first sender corresponds to one of the subset.

In an embodiment, the system has a response message automatically transmitted from the mobile device to the first sender if the first sender does not correspond to any of the contact entries wherein the response message indicates that the first request message was rejected.

In an embodiment, the system has a new contact entry created by the application in response to the first request message if the first sender does not correspond to any of the contact entries wherein the application uses information regarding the first sender which is provided by the request message to create the new contact entry and further wherein the mobile device stores the new contact entry in the contacts database.

In an embodiment, the system has a first response message transmitted with a second contact image associated with a user of the mobile device wherein the application directs the mobile device to transmit the first response message to the first sender in response to the first request message; a second request message from a second sender received by the mobile device after the receipt of the first request message; and a second response message transmitted with a third contact image associated with the user of the mobile device wherein the application directs the mobile device to transmit the second response message to the second sender in response to the second request message and further wherein the third contact image is a different image than the second contact image wherein the second contact image and the third contact images are specified by the user before the mobile device received the first request message.

In an embodiment, the system has a response message transmitted from the mobile device to the first sender wherein the application directs the mobile device to retrieve a second contact image associated with a user of the mobile device from a photo database located remotely relative to the mobile device in response to the first request message and further wherein the response message provides the second contact image to the first sender.

In another embodiment of the present invention, a method for retrieving contact images for a user of a first mobile device having a contact entry stored in a contacts database is provided. The method has the steps of generating a request message wherein the first mobile device generates the request message based on the contact entry; transmitting the request message from the first mobile device to a first electronic address associated with a second mobile device corresponding to the contact entry; and determining if incoming messages received by the first mobile device correspond to the request message wherein the first mobile device determines if a first incoming message provides a first contact image if the first incoming message corresponds to the request message and further wherein the first mobile device automatically stores the first contact image in association with the contact entry if the first incoming message corresponds to the request message and provides the first contact image.

In an embodiment, the method has the step of selecting a second contact image stored by the first mobile device wherein the second contact image is selected by user input on the first mobile device and further wherein selection of the second contact image associates the second contact image with the user of the first mobile device wherein the second contact image is transmitted with the request message from the first mobile device to the second mobile device in response to the selection of the second contact image.

In an embodiment, the method has the step of determining an amount of time which elapsed after the first mobile device stored a second contact image which is associated with the contact entry in the contacts database wherein the first mobile device sends the request message in response to determination by the first mobile device that the amount of time which elapsed after the first mobile device stored the second contact image exceeds a predetermined threshold.

In an embodiment, the method has the step of selecting a set of one or more contact entries from the contacts database wherein the user of the first mobile device selects the set of one or more contacts entries using the first mobile device and further wherein the request message is generated in response to selection of the set of one or more contact entries by the user of the first mobile device.

In an embodiment, the method has the step of transmitting a second request message from the first mobile device to a second electronic address associated with the contact entry which is a different electronic address than the first electronic address wherein the first mobile device automatically sends the second request message without input from the user directing the first mobile device to send the second request message.

It is, therefore, an advantage of the present invention to provide a system and a method for requesting, retrieving and/or associating contact images on a mobile device.

Another advantage of the present invention is to provide a system and a method for requesting, retrieving and/or associating contact images on a mobile device which may enable association of some or all contact entries in a contacts database of the mobile device with corresponding images, such as, for example, photographs.

A further advantage of the present invention is to provide a system and a method for requesting, retrieving and/or associating contact images on a mobile device which may provide a first image to a first requesting party and provide a second image which is a different image than the first image to a second requesting party.

A still further advantage of the present invention is to provide a system and a method for requesting, retrieving, and/or associating contact images on a mobile device which may enable a user of the mobile device to specify a first image to be provided to a first category of remote contacts and a second image which is a different image than the first image to be provided to a second category of remote contacts.

Yet another advantage of the present invention is to provide a system and a method for requesting, retrieving and/or associating contact images on a mobile device which may use peer-to-peer messaging.

Another advantage of the present invention is to provide a system and a method for requesting, retrieving and/or associating contact images on a mobile device which may request and/or may retrieve images for multiple contacts substantially simultaneously.

A further advantage of the present invention is to provide a system and a method which may request, may retrieve and/or may associate contact images for a contacts database of a mobile device without manual control from a user of the mobile device.

Yet another advantage of the present invention is to provide a system and a method for requesting, retrieving and/or associating contact images on a mobile device which may combine methods to query available photograph databases, such as, for example, web-based photo sites and/or social networking sites, with methods to request images directly from peers, such as, for example, using peer-to-peer messaging.

Another advantage of the present invention is to provide a system and a method for requesting, retrieving and/or associating contact images on a mobile device which may use a standard message according to a standard messaging protocol which has additional extensions and/or parameters for automated requesting, retrieval, and association of the contact images to contact entries in a contacts database of the mobile device.

A further advantage of the present invention is to provide a system and a method for requesting, retrieving and/or associating contact images on a mobile device which may enable a user to define and/or send different photographs of the user for different contact groups and/or categories.

Yet another advantage of the present invention is to provide a system and a method for requesting, retrieving and/or associating contact images on a mobile device which may automatically generate messages to request the contact images from users of legacy mobile devices.

Another advantage of the present invention is to provide a system and a method for requesting, retrieving and/or associating contact images on a mobile device which may automatically manage responses to request messages by automatically associating the contact images received in the responses with contact entries in a contacts database of the mobile device.

A further advantage of the present invention is to provide a system and a method for requesting, retrieving and/or associating contact images on a mobile device which may provide photograph version information for a currently associated photograph when requesting an updated photograph for a remote contact.

Yet another advantage of the present invention is to provide a system and a method for requesting, retrieving and/or associating contact images on a mobile device which may use a request message having a “distinguisher” field to enable recipients to distinguish the request message from standard messages which are not request messages.

Another advantage of the present invention is to provide a system and a method for requesting, retrieving and/or associating contact images on a mobile device which may use a request message which delivers an updated photograph of the sender while substantially simultaneously requesting an updated photograph of the recipient.

A further advantage of the present invention is to provide a system and a method for requesting, retrieving and/or associating contact images on a mobile device which may generate and send additional request messages if the mobile device does not receive a response to a first request message.

Yet another advantage of the present invention is to provide a system and a method for requesting, retrieving and/or associating contact images on a mobile device which may generate request messages automatically in response to events, such as, for example, creation of a new contact entry, editing of a contact entry, a lack of response to a previous request message, and/or aging of a currently associated photograph.

Another advantage of the present invention is to provide a system and a method for requesting, retrieving and/or associating contact images on a mobile device which may use a request message having a link to a webpage which enables a recipient of the request message to upload a photograph of the sender of the request message.

A further advantage of the present invention is to provide a system and a method for requesting, retrieving and/or associating contact images on a mobile device which may use an intelligent filter to prevent a user from sending a new request message corresponding to a contact entry in a contacts database of the mobile device if the contact entry has an associated contact image which was updated during a recent time period.

Moreover, an advantage of the present invention is to provide a system and a method for requesting, retrieving and/or associating contact images on a mobile device which may request images for a remote contact using at least two alternate contact addresses associated with the remote contact.

Additional features and advantages of the present invention are described in, and will be apparent from, the detailed description of the presently preferred embodiments and from the drawings.

### BRIEF DESCRIPTION OF THE DRAWINGS

FIG. 1 is a black box diagram of a prior art legacy mobile device.

FIG. 2 is a black box diagram of a mobile device in an embodiment of the present invention.

FIGS. 3 and 5 illustrate systems for requesting, retrieving and/or associating contact images on a mobile device in embodiments of the present invention.

FIG. 4 illustrates an image retrieval message in an embodiment of the present invention.

FIGS. 6-10 illustrate flowcharts of methods for requesting, retrieving and/or associating contact images on a mobile device in an embodiment of the present invention.

### DETAILED DESCRIPTION OF THE PRESENTLY PREFERRED EMBODIMENTS

The present invention generally relates to a system and a method for requesting, retrieving and/or associating contact images on a mobile device. More specifically, the present invention relates to an image retrieval application executed by a first mobile device. The image retrieval application may enable a user of the first mobile device to request images corresponding to remote contacts associated with contact entries stored by a contact database of the first mobile device. The image retrieval application may request a first image from one or more image databases accessible to the first mobile device, and/or the image retrieval application may associate the first image with a first contact entry in the contact database of the first mobile device. If the image databases do not provide the first image requested by the image retrieval application, the image retrieval application may create and/or may send a request message, such as, for example, by sending the request message to a second mobile device associated with the first contact entry. The request message may be based on a standard messaging format with extensions added to enable processing by the image retrieval application.

If the second mobile device has a compatible application, the compatible application of the second mobile device may automatically receive and/or respond to the request message. The response may provide the first image, such as, for example, a photograph previously specified by a first remote contact associated with the first contact entry for the compatible application to use in response to request messages. If the second mobile device does not have a compatible application, the request message may be interpreted as a standard messaging format which the first remote contact may receive, may view and/or may use for response. For example, the request message may be an SMS message, an MMS message, an email message and/or the like. The request message may provide human-readable instructions which may instruct the first remote contact to send a reply message to the request message and/or to attach the first image to the reply message.

A second image may be attached to the request message. The second image may be extracted by the compatible application on the second mobile device and/or may be associated with the user of the first mobile device in the second mobile device. If the second mobile device has the compatible application, extraction of the second image and/or association of the second image with the user of the first mobile device may be performed automatically by the compatible application of the second mobile device. Alternatively, the extraction and/or the association may be performed manually by the remote contacts, such as, for example, by manually saving the second image using a save attachment function of a messaging application on the second mobile device and/or by manually associating the second image with the user of the first mobile device in the second mobile device.

The image retrieval application on the first mobile device may receive responses which may correspond to the request messages sent by the image retrieval application to the remote contacts. The image retrieval application may automatically parse the responses, may identify images provided by the responses, and/or may associate the images with the contact entries corresponding to the remote contacts. The image retrieval application may address situations where a response is not received by the first mobile device and/or where the response does not provide an image. For example, the image retrieval application may monitor whether a response corresponding to the request message was received. If the response is not received during a predetermined time period, the image retrieval application may send one or more additional request messages to the remote contact. As another example, the image retrieval application may notify the user if the response does not provide an image and/or may enable the user to determine whether to transmit the additional request messages to the remote contact.

The image retrieval application may be configurable by the user to establish an amount of user interaction during image retrieval. In an embodiment, the image retrieval application may enable the user to configure the image retrieval application to automatically reply to incoming request messages using a default image and/or to prompt the user to confirm whether to send the default image in response to each of the incoming request messages. In an embodiment, the image retrieval application may enable the user to specify that the image retrieval application automatically replies to the incoming request message using the default image if the incoming request message corresponds to one of the contact entries in the contact database and/or in a specified subset of the contact entries. The image retrieval application may enable the user to specify that the image retrieval application queries the user how to respond to the incoming request message if the incoming request message does not correspond to one of the contact entries in the contact database and/or in the specified subset of the contact entries. The image retrieval application may enable the user to specify that the image retrieval application rejects an incoming request message from an unknown party without consulting the user.

Referring now to the drawings wherein like numerals refer to like parts, FIG. 1 generally illustrates a prior art legacy mobile device 10. The legacy mobile device 10 may have a camera module 11 which may allow a first user of the legacy mobile device 10 to create a photograph. The legacy mobile device 10 may have a storage module 12, and/or the first user may store the photograph in the storage module 12. For example, the first user may use the camera module 11 to create a photograph of the first user to be shared with contacts of the first user. As a further example, the first user may use the camera module 11 to create a photograph of a second user, such as, for example, a physically present contact. The first user may use the legacy mobile device 10 to associate the photograph with a contact entry corresponding to the second user.

A contacts application 13 may allow the first user to edit, view and/or search contact entries which may be stored in the storage module 12 as a contacts database. The contacts application 13 and/or the contacts database may associate each of the contact entries with a second user. Each of the contact entries may have fields, such as, for example, contact name, phone numbers, email addresses, category, photograph, speed-dial number and/or the like. The contacts application 13 may allow the first user to select a photograph from the storage module 12 to be associated with one of the contact entries. The contacts application 13 may enable the first user to indicate a selected contact entry, and/or the legacy mobile device 10 may initiate a phone call and/or send a message to the second user associated with the selected contact entry.

The legacy mobile device 10 may have a messaging application 14 which may support sending and receipt of one or more message types, such as, for example, SMS, MMS and/or email. The messaging application 14 may allow the first user to create, compose, edit and/or send outgoing messages. The messaging application 14 may allow the first user to receive, view, read and/or reply to incoming messages. If replying to one of the incoming messages, the messaging application 14 may copy the body of the one of the incoming messages to an outgoing reply message, and/or the messaging application 14 may allow the first user to edit the body of the outgoing reply message. The messaging application 14 may allow the first user to provide an attachment, such as, for example, a photograph, to the outgoing messages, such as, for example, the outgoing reply message.

The messaging application 14 may send the outgoing messages and/or the outgoing reply message to a recipient address through a network interface 15 of the legacy mobile device 10. A copy of the outgoing messages and/or the outgoing reply message may be stored in the storage module 12. The messaging application may receive the incoming messages through the network interface 15. The incoming messages may be viewed on the legacy mobile device 10 using the messaging application 14 and/or may be stored in the storage module 12. Attachments received with the incoming messages may be viewed on the legacy mobile device using the messaging application 14 and/or a separate application on the legacy mobile device 10, such as, for example, an image viewer application. The attachments may be stored in the storage module 12 for subsequent retrieval, viewing and/or use.

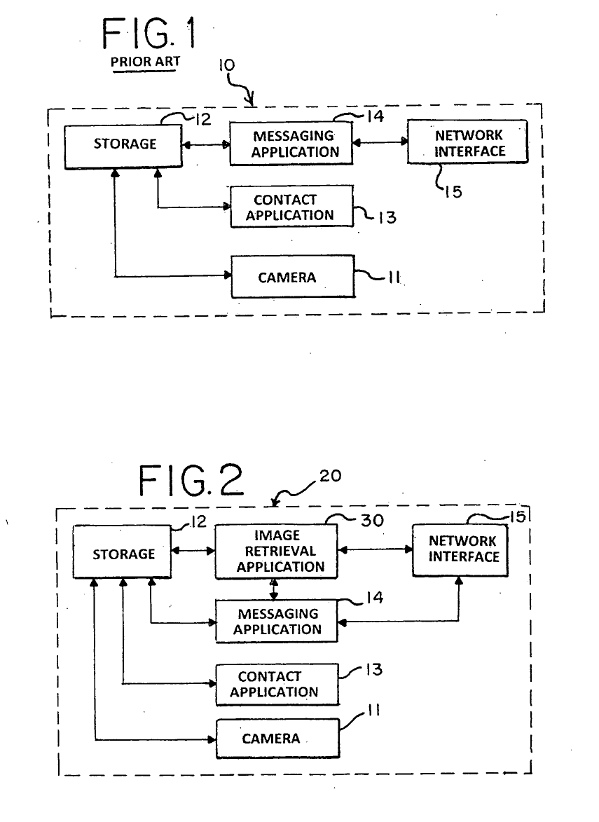

FIG. 2 generally illustrates a mobile device 20 in an embodiment of the present invention. The mobile device 20 may have the camera module 11, the storage module 12, the contacts application 13, the messaging application 14 and/or the network interface 15. These elements may have the capabilities and/or the functions described previously for the legacy mobile device 10. The legacy mobile device 10 and/or the mobile device 20 may be a personal digital assistant (PDA), a mobile telephone, and/or the like. The present invention is not limited to a specific embodiment of the legacy mobile device 10 and the mobile device 20, and the legacy mobile device 10 and the mobile device 20 may be any mobile device known to one having ordinary skill in the art.

The mobile device 20 may have an image retrieval application 30. The image retrieval application 30 may be installed on the mobile device 20, the operating system of the mobile device 20, a “phonebook” application on the mobile device 20, and/or the like. Alternatively, the image retrieval application 30 may be a separate application executed by the mobile device 20. For example, the image retrieval application 30 may be a pre-installed application that may be installed on the mobile device 20 before purchase of the mobile device 20 by the first user. Alternatively, the image retrieval application may be an application which may be obtained by and/or installed by the first user of the mobile device.

For example, FIG. 2 depicts the image retrieval application 30 separately from the camera module 11, the storage module 12, the contacts application 13, the messaging application 14 and/or the network interface 15. However, the image retrieval application 30 may not reside in a single, dedicated application on the mobile device 20. For example, the image retrieval application 30 may be combined with another element, such as, for example, the contacts application 13 and/or the messaging application 14. Alternatively, the image retrieval application 30 may be separated into several separate sub-applications. Some or all of the sub-applications may be combined with other pre-installed applications and/or user-installed applications on the mobile device 20. The present invention is not limited to a specific means of implementing or organizing the image retrieval application 30, and FIG. 2 does not limit the image retrieval application 30 to a specific implementation structure.

As shown in FIG. 2, the image retrieval application 30 may connect to the network interface 15 and/or the messaging application 14 of the mobile device 20. Connection of the image retrieval application 30 to the network interface 15 may enable the image retrieval application 30 to send outgoing image retrieval request messages, to receive incoming image retrieval response messages, to query an external database for images, and/or the like. Connection of the image retrieval application 30 to the messaging application 14 may enable the image retrieval application 30 to access the incoming messages received by the messaging application 14. The incoming messages may be, for example, incoming image retrieval request messages and/or incoming image retrieval response messages which may be processed by the image retrieval application 30. The connection of the image retrieval application 30 to the messaging application 14 may enable the image retrieval application 30 to create, format, verify and/or send the outgoing image retrieval request messages and/or the outgoing image retrieval response messages.

The image retrieval application 30 may connect to the storage element 12 of the mobile device 20. As a first example, the image retrieval application 30 may access the contacts database of the mobile device 20 which may be stored in the storage module 12. As a second example, the image retrieval application 30 may access images which may be stored in the storage module 12. For example, the images may be photographs of second users associated with corresponding contact entries and/or may be photographs of the first user which may be designated by the first user for sharing with the second users. The second users may be located remotely relative to the first user and/or the mobile device 20. As a third example, the image retrieval application 30 may create records in the storage module 12 for later retrieval. Accordingly, the image retrieval application 30 may record a state of messages sent and/or received to obtain an image from one or more of the second users. In an embodiment, the image retrieval application 30 may record one or more message identifiers and/or state variables which may correspond to an outgoing image retrieval request message. Subsequently, the image retrieval application 30 may retrieve, may refer to and/or may use the message identifiers and/or the state variables when a corresponding image retrieval response message is received and/or when another event relevant to the outgoing image retrieval request message occurs.

The image retrieval application 30 may connect to other elements of the mobile device 20 using other connections not shown in FIG. 2. For example, the image retrieval application 30 may connect to the contacts application 13 to access the contacts database through the contacts application 13 instead of directly accessing the contacts database in the storage module 12. As another example, the image retrieval application 30 may connect to the contacts application 13 to receive instructions from the first user to retrieve images for the contact entries if the first user creates the instructions using the contacts application 13. One having ordinary skill in the art will recognize other connections and/or configurations which may differ from the connections and/or the configurations of FIG. 2 but which still maintain the spirit and function of the present invention as described herein.

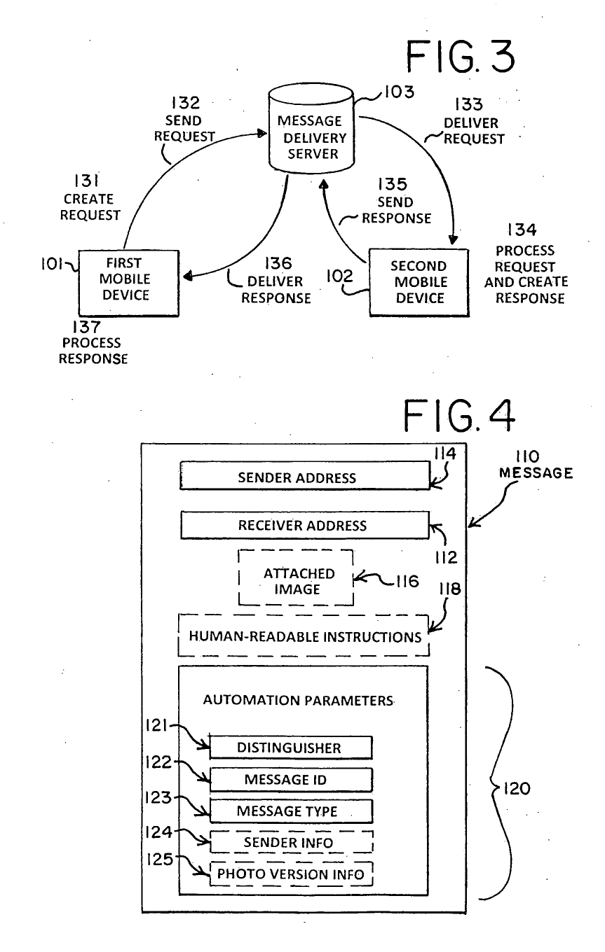

FIG. 3 generally illustrates an exchange of the image retrieval request messages and the image retrieval response messages in an embodiment of the present invention. A first mobile device 101 may be associated with a first user, and/or a second mobile device 102 may be associated with a second user. The second mobile device 102 and/or the second user may be located remotely relative to the first mobile device 101 and/or the first user. The first mobile device 101 may send a first image retrieval request message to the second mobile device 102 using a message delivery server 103 as described in more detail hereafter. The first mobile device 101 may be the mobile device 20 which has the image retrieval application 30. The second mobile device 102 may be the mobile device 20 which has the image retrieval application 30, or the second mobile device 102 may be the legacy mobile device 10 which lacks the image retrieval application 30.

FIG. 3 generally illustrates sending the image retrieval request message to a single remote contact, namely the second mobile device 102. However, the image retrieval application 30 of the first mobile device 101 may generate image retrieval request messages substantially simultaneously to request and/or retrieve images for multiple remote contacts. Each of the image retrieval request messages may be separately generated, sent, tracked and/or processed by the image retrieval application 30 of the first mobile device 101 as depicted in FIG. 3.

One or more networks (not shown) may connect the first mobile device 101 and/or the second mobile device 102 to the message delivery server 103. For example, a mobile operator network, such as, for example, a 3G mobile network, may connect the first mobile device 101 to the message delivery server 103. As another example, an IEEE 802.11 (“WiFi”) connection to the internet may connect the second mobile device 102 to the message delivery server 103. The present invention is not limited to a specific means by which the first mobile device 101 and/or the second mobile device 102 may connect to the message delivery server 103.

The message delivery server 103 may be a standard server for delivering electronic messages between endpoints. For example, the message delivery server 103 may be an SMS Server, an MMS Server, an email server, and/or the like. FIG. 3 depicts one of the message delivery server 103. However, the image retrieval request message and the image retrieval response message may be routed through more than one of the message delivery server 103. The present invention is not limited to a specific number of the message delivery server 103.

In step 131 of FIG. 3, the image retrieval application 30 and/or the first mobile device 101 may create the image retrieval request message which may be a message sent to the second mobile device 102 and/or the second user. The image retrieval request message may request an image, such as, for example, a photograph of the second user. The image retrieval request message may be created and/or transmitted after a failed attempt to retrieve the image from an accessible photo database, such as, for example, Facebook.

Creation and/or transmittal of the image retrieval request message in step 131 may be in response to user input on the first mobile device 101 directing the first mobile device 101 to create and/or transmit the image retrieval request message. Alternatively, the creation and/or the transmittal of the image retrieval request message may occur at predetermined time intervals and/or in response to a triggering event. The triggering event may be, for example, a timeout event as discussed in more detail hereafter; creation of a contact entry for the remote contact using the contacts application 14; editing of the contact entry for the remote contact using the contacts application 14; the first user creating, changing and/or updating the image associated with the first user; determination that the current image associated with the second user is older than an age threshold; and/or the like. For example, the image retrieval application 30 may generate the image retrieval request message once every six months and/or whenever an image associated with a contact was obtained over one year ago. The present invention is not limited to specific embodiments of the predetermined time intervals or the triggering event.

In an embodiment, the image retrieval request message created by the image retrieval application 30 may have an attached image for delivery to the second mobile device 102 and/or the second user with the image retrieval request message. For example, the image retrieval application 30 may attach a photograph of the first user associated with the first mobile device 101 to the image retrieval request message.

For example, the first user may designate a “suit-and-tie” photograph to use for business associates. The first user may replace the “suit-and-tie” photograph with an updated “suit-and-tie” photograph, such as, for example, a more recent photograph. Updating of the image may be a triggering event which may direct the image retrieval application 30 and/or the first mobile device 101 to send the image retrieval request message to the business associates. The image retrieval request message may provide the updated “suit-and-tie” photograph to the business associates and/or may request images, such as, for example, updated images from the business associates. The “suit-and-tie” photograph may not have been designated for other contact groups, such as, for example, family of the first user. Accordingly, the image retrieval application 30 may not send image retrieval request messages to the family of the first user in response to the updating of the image designated for use with the business associates.

In an embodiment, the image retrieval application 30 may implement a filter. The filter may prevent creation and/or transmittal of the image retrieval request messages. In an embodiment, if an image associated with a remote contact was received within a predetermined time period, the image retrieval application 30 and/or the first mobile device 101 may prevent the first user from creating and/or sending an image retrieval request message to the remote contact. In another embodiment, the image retrieval application 30 and/or the first mobile device 101 may inform the first user of receipt of the image for the remote contact within the predetermined time period and/or may query the first user whether to create and/or send the image retrieval request message. The first user may establish the predetermined time period.

For example, the first user may direct the first mobile device 101 and/or the image retrieval application 30 on the first mobile device 101 to obtain images from all of the contact entries in the contacts database of the first mobile device 101. The image retrieval application 30 on the first mobile device 101 may determine which of the contact entries are associated with images obtained in a predetermined time period, such as, for example, the previous six months. The image retrieval application 30 on the first mobile device 101 may send image retrieval request messages to the contact entries which are not associated with images obtained in a predetermined time period, such as, for example, the previous six months. The image retrieval application 30 may not send image retrieval request messages to the contact entries which are associated with images obtained in a predetermined time period such as, for example, the previous six months. Alternatively, the image retrieval application 30 on the first mobile device 101 may query the first user whether to create and/or send the image retrieval request messages to the contact entries which are associated with images obtained in a predetermined time period such as, for example, the previous six months.

The second user and/or the contact entry associated with the second user in the contacts database of the first mobile device 101 may have alternate contact addresses. For example, the second user may have a home phone number, a mobile phone number, a business phone number, and/or an email address. In an embodiment, the image retrieval application 30 on the first mobile device 101 may generate and/or may send image retrieval request messages for more than one of the alternate contact addresses. For example, the image retrieval application 30 on the first mobile device 101 may send a first image retrieval request message to the mobile phone number of the second user, such as, for example, the phone number of the second mobile device 102. If the image retrieval application 30 on the first mobile device 101 does not receive an image retrieval response message during a predetermined time period, receives an error, and/or exhausts of a preset number of additional image retrieval request messages, the image retrieval application 30 on the first mobile device 101 may generate and/or may send a second image retrieval request message to the email address associated with the second user.

In step 132 of FIG. 3, the first mobile device 101 may send the image retrieval request message to the message delivery server 103. In step 133, the message delivery server 103 may send the image retrieval request message to the second mobile device 102 and/or the second user. In step 134, the second mobile device 102 may process the image retrieval request message and/or may create an image retrieval response message which may respond to the image retrieval request message. The image retrieval response message may provide an image to the mobile device which sent the image retrieval request message, namely the first mobile device 101. For example, the image may be a photograph of the second user associated with the second mobile device 102. Further, if the image retrieval response message does not have an image, the image retrieval response message may indicate that the image retrieval request message was rejected by the image retrieval application 30 of the second mobile device 102.

The image retrieval application 30 on the second mobile device 102 may provide an alert which the second mobile device 102 may display to the second user. The alert may notify the second user that the image retrieval request message was received and/or may query the second user for instructions in responding to the image retrieval request message. In an embodiment, the image retrieval application 30 may create and/or may maintain a list of image retrieval events, such as, for example, receipt of an image retrieval request message and/or an image retrieval response message, transmittal of an image retrieval request message and/or an image retrieval request message, error conditions which occurred during image retrieval, success and/or failure of image retrieval, and/or the like. The second mobile device 102 and/or the image retrieval application 30 on the second mobile device 102 may display the list when one of the image retrieval events occurs, at a predetermined time interval, in response to user input from the second user requesting display of the list, and/or the like.

In an embodiment, the image retrieval request message may provide a hyperlink which may reference a web page. For example, the web page referenced by the hyperlink may be provided by a web server of a mobile network operator. The second user may use the second mobile device 102 to select the hyperlink to connect to and/or to display the web page on the second mobile device 102. Alternatively, the second user may use the hyperlink in a web browser of another device, such as, for example, a laptop PC, a desktop PC and/or the like. The web page may enable the second user to upload the image requested by the first user, such as, for example, a photograph of the second user. The web page may enable the second user to obtain an image for the first user, such as, for example, a photograph of the first user. Accordingly, the hyperlink and/or the web page may enable the second user to respond to the image retrieval request message without sending the image retrieval response message. For example, if the second mobile device 102 is limited to text-only messaging technologies, such as, for example, if the second mobile device 102 is a mobile phone which has SMS messaging capabilities and lacks MMS and email capabilities, the hyperlink and/or the web page may enable the second user to respond to the image retrieval request message.

Means for creation of the image retrieval response message in step 134 may depend on whether the second mobile device 102 is the mobile device 20 which has the image retrieval application 30 or the legacy mobile device 10 which lacks the image retrieval application 30. If the second mobile device 102 is the mobile device 20 which has the image retrieval application 30, the image retrieval application 30 on the second mobile device 102 may access and/or may process the image retrieval request message to create the image retrieval response message. Processing of the image retrieval request message may involve determination whether the image retrieval request message has an attached image. For example, the image retrieval application 30 on the second mobile device 102 may determine whether the image retrieval request message has the attached image. The attached image may be a photograph of the first user associated with the first mobile device 101. If the image retrieval request message has the attached image, the image retrieval application 30 on the second mobile device 102 may execute a “Save” function. Executing the “Save” function may store the attached image from the image retrieval request message to the storage module 12 of the second mobile device 102. Further, executing the “Save” function may identify a corresponding contact entry in the contacts database of the second mobile device 102 for the attached image. Identification of the corresponding contact entry may use information provided by the image retrieval request message which may identify the sender of the image retrieval request message as described in more detail hereafter. Still further, executing the “Save” function may associate the attached image with the corresponding contact entry in the contacts database of the second mobile device 102.

In an embodiment, the image retrieval application 30 on the second mobile device 102 may automatically create the image retrieval response message in step 134. In this embodiment, the image retrieval application 30 may create the image retrieval response message based on fixed logic defined for the image retrieval application 30 and/or based on preferences established by the second user of the second mobile device 102. The fixed logic and/or the preferences may enable the image retrieval application 30 to determine whether to respond to the image retrieval request message, whether to provide an image with the image retrieval response message, and/or which image is appropriate to provide with the image retrieval response message. Further, the fixed logic and/or the preferences may enable the image retrieval application 30 to determine whether to create the image retrieval response message in an automatic fashion, or, alternatively, to prompt the second user of the second mobile device 102 for input before creating the image retrieval response message.

As a first example, an embodiment of the image retrieval application 30 on the second mobile device 102 may not consider user preferences in the creation of the image retrieval response message in step 124. For example, the fixed logic may direct the image retrieval application 30 to respond automatically with a default image if the image retrieval request message corresponds to one of the contact entries in the contacts database of the second mobile device 102. The fixed logic may direct the image retrieval application 30 to prompt the second user to instruct the image retrieval application 30 how to respond if the image retrieval response message does not correspond to any of the contact entries in the contacts database of the second mobile device 102.

As a second example, an embodiment of the image retrieval application 30 on the second mobile device 102 may enable the second user to establish preferences for the creation of the image retrieval request message in step 134. The preferences may enable the second user to select between various modes. For example, the image retrieval application 30 may provide a “manual” mode. For the “manual” mode, the image retrieval application 30 and/or the second mobile device 102 may query the second user for instructions. For example, the instructions may indicate whether to respond to an image retrieval request message with an image retrieval response message providing an image and/or to reject the image retrieval request message.

The image retrieval application 30 may provide a first “completely automatic” mode in which the image retrieval application 30 may respond automatically. For example, the image retrieval application 30 may respond automatically to image retrieval request messages corresponding to one of the contact entries in the contacts database of the second mobile device 102. For example, the second mobile device 102 and/or the image retrieval application 30 may automatically respond with image retrieval response messages providing an image. In the first “completely automatic” mode, the image may be selected automatically based on a contacts group and/or category for the contact entry, and/or the image may be a default image.

The image retrieval application 30 may provide a second “completely automatic” mode in which the image retrieval application 30 may reject all of the image retrieval request messages. For example, in the second “completely automatic” mode, the image retrieval application 30 may reject the image retrieval request messages regardless of whether the image retrieval response messages correspond to any of the contact entries in the contacts database of the second mobile device 102.

The image retrieval application 30 may provide a first “semi-automatic” mode in which the image retrieval application may respond automatically in some situations and/or may require user input in other situations. For example, the image retrieval application 30 may respond automatically to the image retrieval request messages which correspond to a preferred subset of the contact entries in the contacts database of the second mobile device 102. The image retrieval application 30 may respond automatically by sending image retrieval response messages providing an image. The preferred subset may be defined by the second user on the second mobile device 102. In the first “semi-automatic” mode, the image retrieval application 30 may prompt the second user for instructions for responding to the image retrieval request messages which do not correspond to the preferred subset. In an embodiment of the first “semi-automatic” mode, the image retrieval application 30 may ignore the image retrieval response messages which do not correspond to any of the contact entries in the contacts database of the second mobile device 102.

The image retrieval application 30 may provide a second “semi-automatic” mode in which the image retrieval application 30 may respond automatically in some situations and/or may require user input in other situations. For example, the image retrieval application 30 may respond automatically to the image retrieval request messages which correspond to a group and/or a category of the contact entries in the contacts database of the second mobile device 102. For example, the image retrieval application 30 may respond with image retrieval response messages which provide an image. The group and/or the category may be, for example, “family members,” “co-workers,” “friends,” “significant other” and/or the like. In the second “semi-automatic” mode, the image retrieval application 30 may prompt the second user for instructions for responding to the image retrieval request messages which do not correspond to the group and/or the category. In an embodiment of the second “semi-automatic”mode, the image retrieval application 30 may ignore the image retrieval response messages which do not correspond to any of the contact entries in the contacts database of the second mobile device 102.

The modes described above are examples; in a specific embodiment, the image retrieval application 30 may implement all of the modes, may implement a subset of the modes, may implement other modes which use features of the modes described above, and/or may use other modes not specifically described above. In an embodiment, the image retrieval application 30 may not implement any of the modes listed above.

In step 134, if the second mobile device 102 is the legacy mobile device 10 which lacks the image retrieval application 30, the image retrieval request message may be interpreted as a standard message, such as, for example, an SMS, an MMS, an email message and/or the like. The image retrieval request message may have a standard message header which may enable the messaging application 14 on the second mobile device 102 to receive, process and/or display the image retrieval request message to the second user. The second mobile device 102 may display the image retrieval request message with other standard messages which may not be image retrieval request messages. The image retrieval request message may have human-readable instructions which may direct the second user in replying manually to the image retrieval request message.

For example, the human-readable instructions may be: “Hi Alice—here's a current photo of me, you can save this and use it on your phone. I'd like to get an updated photo of you to use on my phone. To send me one, please reply to this message and attach your photo. Please don't edit the subject line, it has a code that helps me automatically use the photo you send. I'm using a cool app called ContactPix to do this—you can get it too, see www.contactpix.com to download the application!Thanks, Bob”

The human-readable instructions may be generated automatically by the image retrieval application 30 of the first mobile device 101 when the image, retrieval request message is created in step 131. Alternatively, the image retrieval application 30 of the first mobile device 101 may enable the first user to provide some or all of the text of the human-readable instructions. The first user may provide some or all of the text of the human-readable instructions when the image retrieval request message is created in step 131. The first user may provide some or all of the text of the human-readable instructions before creation of the image retrieval request message so that the text may be used as default text for the image retrieval request messages sent by the first mobile device 101.

The second user of the second mobile device 102 may follow the human-readable instructions. The second user of the second mobile device 102 may save the attached image provided by the image retrieval request message. The second user of the second mobile device 102 may reply to the image retrieval request message and/or may attach an image, such as, for example, a photograph of the second user, to a reply message. Accordingly, the second user of the second mobile device 102 may manually process the image retrieval request message and/or manually create the reply message that may function as the image retrieval response message to complete step 134 of FIG. 3.

In step 135, the second mobile device 102 may send the image retrieval response message to the message delivery server 103. In step 136, the message delivery server may send the image retrieval response message to the first mobile device 101 and/or the first user. In step 137, the first mobile device 101 may receive and/or may process the image retrieval response message. For example, the image retrieval application 30 on the first mobile device 101 may analyze the image retrieval response message to associate the image retrieval response message with the image retrieval request message to which the image retrieval response message responds. The image retrieval application 30 on the first mobile device 101 may analyze the image retrieval response message and/or the image retrieval request message to which the image retrieval response message responds to associate the image retrieval response message with a contact entry in the contacts database of the first mobile device 101.

The image retrieval application 30 on the first mobile device 101 may provide an alert which the first mobile device 101 may display to the first user. The alert may notify the first user that the image retrieval response message was received. As previously discussed, in an embodiment, the image retrieval application 30 may create and/or may maintain a list of image retrieval events, such as, for example, receipt of an image retrieval request message and/or an image retrieval response message, transmittal of an image retrieval request message and/or an image retrieval request message, error conditions which occurred during image retrieval, success and/or failure of image retrieval, and/or the like. Accordingly, the first mobile device 101 and/or the image retrieval application 30 on the first mobile device 102 may display the list when one of the image retrieval events occurs, at a predetermined time interval, in response to user input from the first user requesting display of the list, and/or the like.

If the image retrieval response message provides an image, such as, for example, a photograph of the second user, the image retrieval application 30 on the first mobile device 101 may execute the “Save” function as previously described. If the image retrieval response message does not provide an image and/or indicates rejection of the image retrieval request message, the image retrieval application 30 on the first mobile device 101 may notify the first user, may record an error, may request instructions from the first user, may send an additional image retrieval request message to the second user, and/or the like. If the image retrieval response message has syntax problems, cannot be associated with previous outgoing image retrieval request messages, and/or cannot be associated with contact entries in the contacts database of the first mobile device 101, the image retrieval application 30 may perform an action. The action may be, for example, notifying the first user, recording an error, requesting instructions from the first user, sending an additional image retrieval request message to the second user, and/or the like.

The image retrieval response message generated by the second mobile device 102 may erroneously use the attached image of the first user. For example, the second mobile device 102 may be the legacy mobile device 10 which lacks the image retrieval application 30, and/or a “reply” function of the messaging application 14 on the legacy mobile device 10 may automatically copy an attachment from the image retrieval request message into the image retrieval response message. In an embodiment, the image retrieval application 30 on the first mobile device 101 may examine the attachment received with the image retrieval response message to determine whether the attachment may be a copy of the attached image of the image retrieval request message. If the image retrieval application 30 on the first mobile device 101 determines that the attachment received with the image retrieval response message is a copy of the attached image of the image retrieval request message, the image retrieval application 30 may ignore the attachment when executing the “save” function, may inform the first user, may send an additional image retrieval request message to the user, and/or the like.

The image retrieval application 30 on the first mobile device 101 may update the records in the storage module 12 which correspond to the image retrieval request message. For example, the image retrieval application 30 may update the records to indicate that the image retrieval request message resulted in successful photo retrieval, that the image retrieval request message was rejected, that the image retrieval request message generated an error, and/or the like.

FIG. 4 generally illustrates an image retrieval message 110 in an embodiment of the present invention. The image retrieval message 110 generally illustrated in FIG. 4 may function as an image retrieval request message and/or an image retrieval response message. As discussed previously, the image retrieval message 110 may be formed using a standard messaging syntax to which extension elements and/or fields may be added. Therefore, the various elements of the image retrieval message 110 generally illustrated in FIG. 4 may be represented as standard message headers, as extended message headers using an extension mechanism of the messaging protocol, as portions of message headers, and/or as portions of the body of the standard message. In an embodiment, the elements of the image retrieval message 110 may be combined into a single element and/or may coexist within a single standard and/or extended message header. The image retrieval message 110 may have a recipient address 112 which may identify the recipient of the image retrieval message 110 and/or which may enable delivery of the image retrieval message 110 to the recipient by the message delivery server 103. The recipient may be, for example, the second user which may be located remotely relative to the first user and/or the first mobile device 101. In an embodiment, the recipient address 112 may be carried in a standard message header and/or field. For example, the recipient address 112 may be carried in the “to” field, the “cc” field, and/or a similar destination address field of a well-known messaging protocol, such as, for example, email and/or MMS.

The image retrieval message 110 may have a sender address 114 which may identify the sender of the image retrieval message 110. The sender address 114 may enable a response message to be delivered to the sender by the message delivery server 103. The sender may be, for example, the first user. In an embodiment, the sender address 114 may be carried in a standard message header and/or field. For example, the sender address 114 may be carried in the “from” field, the “sender” field, the “reply-to” field, and/or a similar standard field of a well-known messaging protocol, such as, for example, email and/or MMS.

The image retrieval message 110 may have the attached image 116, such as, for example, a photograph of the sender. In an embodiment, the attached image 116 may be an image object attached to the image retrieval message 110 using standard attachment procedures. For example, the attached image 116 may be an image object attached to an email and/or an MMS using Multi-Purpose Internet Mail Extensions (MIME) Multi-Part structure as defined in standards from the Internet Engineering Task Force (IETF). The image object may be any image object known to one having ordinary skill in the art. For example, the image object 116 may be a JPEG image file, a bitmap image file, a TIFF image file, a GIF image file, an animated GIF image file, and/or the like. The present invention is not limited to a specific embodiment of the attached image 116.

The image retrieval message 110 may have the human-readable instructions 118. In an embodiment, the human-readable instructions 118 may be located in the body of the image retrieval message 110 as defined in a standard messaging format. If the image retrieval message 110 follows the MIME/Multi-Part format, the human-readable instructions 118 may be text-represented as a part with a MIME type of “text/plain.” Alternatively, the human-readable instructions 118 may be represented in any manner which enables the recipient of the image retrieval message 110 to access, view, read and/or understand the human-readable instructions 118.

The image retrieval message 110 may have one or more retrieval automation parameters 120 which may enable automatic processing of the image retrieval message 110 by the image retrieval application 30 which receives the image retrieval message 110. For example, the retrieval automation parameters 120 may be and/or may have a distinguisher parameter 121, a message identifier 122, a message type 123, sender information 124 and/or image version information 125 as discussed in more detail hereafter.

The image retrieval application 30 which creates the image retrieval message 110 may provide the retrieval automation parameters 120 to enable the image retrieval application 30 of the recipient to automatically process the image retrieval message 110. The image retrieval application 30 which creates the image retrieval message 110 may provide the retrieval automation parameters 120 to enable itself to automatically process the image retrieval response message generated by the recipient in reply to the image retrieval message 110. The image retrieval application 30 which receives the image retrieval message 110 may copy the retrieval automation parameters 120 from the image retrieval message 110 into the image retrieval response message and/or may add additional retrieval automation parameters.

The messaging application 14 of the mobile device 10 which lacks the image retrieval application 30 may copy the retrieval automation parameters 120 from the image retrieval message 110. For example, the messaging application 14 may copy the retrieval automation parameters 120 into a manually created image retrieval response message when the recipient replies to the image retrieval request message using the messaging application 14. For example, the retrieval automation parameters 120 may be encoded as text in the body of the image retrieval request message, and/or a “Reply” function of the messaging application 14 may copy the text into the body of the image retrieval response message. Alternatively, the retrieval automation parameters 120 may be encoded into one or more standard header fields which may be copied into the image retrieval response message. Accordingly, the retrieval automation parameters 120 may be carried through steps 131-137 of FIG. 3 for use by the image retrieval application 30 of the first mobile device 101 and/or the image retrieval application 30 of the second mobile device 102.

The image retrieval message 110 may have and/or may provide the distinguisher parameter 121 which may distinguish the image retrieval message 110 from standard messages which are not an image retrieval message 110. For example, the distinguisher parameter 121 may be a distinguishing string, such as, for example, “PRS-Proto-gx28149,” “PRS-message-v08” and/or the like. The distinguisher parameter 121 may be carried in a standard message header, an extended message header, the body of the image retrieval message 110, and/or the like. In a preferred embodiment, the distinguisher parameter 121 may be a complex pattern which may be unlikely to occur by accident in a standard message which is not an image retrieval message 110. Thus, the image retrieval application 30, the messaging application 14, the network interface 15, and/or another element may determine whether a message is an image retrieval message 110 based on the presence or absence of the distinguisher parameter 121.

The image retrieval message 110 may have and/or may provide the message identifier 122 which may identify the image retrieval request message and/or the image retrieval response message corresponding to the image retrieval request message. For example, the image retrieval application 30 may generate a unique value for the message identifier 122 for each of the image retrieval request messages sent by the image retrieval application 30. As another example, the image retrieval application 30 may use the message identifier 122 provided by an incoming image retrieval response message to determine the image retrieval request message corresponding to the image retrieval response message. The image retrieval application 30 may copy the message identifier 122 from an image retrieval request message into a corresponding image retrieval response message.

The image retrieval message 110 may have and/or may provide the message type 123 which may indicate the type of the image retrieval message 110. For example, the message type 123 may indicate that the image retrieval message 110 is an image retrieval request message 110 or an image retrieval response message. The message type 123 may indicate additional information. For example, the message type 123 may indicate that the image retrieval message 110 is an image retrieval response message with an attached image, an image retrieval response message without an attached image, an image retrieval response message which rejects the image retrieval request message, and/or the like. As another example, the message type 123 may indicate that the image retrieval message 110 is an original image retrieval request message, an update image retrieval request message, an additional image retrieval request message, and/or the like. The present invention is not limited to a specific embodiment of the message type 123, and other message types may be used in embodiments of the present invention.

The image retrieval message 110 may have and/or may provide the sender information 124 which may indicate information about the sender of the image retrieval message 110. The information may indicate a name of the sender, a telephone number of the sender, a unique identifier for the sender, contact information for the sender, an email address of the sender, a SIP address of the sender, a nickname of the sender, and/or the like. The sender information 124 may be formatted in a standard contact information format, such as, for example, “VCard” format defined by IETF, and/or in a non-standard format defined for information exchange between the image retrieval application 30 of the sender and the image retrieval application 30 of the recipient. The image retrieval application 30 of the recipient may use the sender information 124 to identify the sender within the contacts database of the recipient. Therefore, the sender information 124 may assist and/or may enable the image retrieval application 30 of the recipient to automatically associate the attached image with the corresponding contact entry in the contacts database of the recipient. The image retrieval application 30 may use the sender information 124 to update the contact information for the sender in the contacts database of the recipient.

The image retrieval message 110 may have and/or may provide image version information 125 which may indicate a version of the image which the sender currently uses and/or which the sender currently associates with the contact entry of the recipient in the contacts database of the sender. For example, the image version information 125 may have a filename, a filesize, a file creation date, a date the image was created, a date the photograph was taken, a size of the image, a thumbnail image of the image, a hash value computed from the image, and/or the like. The recipient and/or the image retrieval application 30 of the recipient may use the image version information 125 to determine whether the sender has the current image of the recipient. Based on the image version information 125, the recipient and/or the image retrieval application 30 of the recipient may send an image retrieval response message with an updated image of the recipient, may send an image retrieval response message without an attached image, may send an image retrieval response message rejecting the image retrieval request message, and/or the like. For example, the updated image may be a more recently taken photograph relative to the previous image described by the image version information 125. If the sender has no image currently associated with the contact entry of the recipient in the contacts database of the sender, the image version information 125 may be absent from the image retrieval message 110. In an embodiment, if the sender has no image currently associated with the contact entry of the recipient, the image version information 125 may indicate that no image is currently associated with the contact entry.

The image retrieval application 30 may use messaging technology with per message costs. For example, the image retrieval message 110 may be sent using standard MMS messages with PRS-specific extensions. For some users, sending and/or receiving MMS messages may incur a per message cost. For other users, there may be no per message cost. For example, a mobile operator may offer a service plan which has unlimited messaging for a fixed price. Various approaches may mitigate the cost of sending the image retrieval message 110. For example, a mobile operator may bundle the image retrieval application 30 and/or an image retrieval service with an unlimited messaging service at a fixed monthly cost. As another example, a mobile operator may allow the image retrieval message 110 to be delivered as a free message within the network of the mobile operator, and/or multiple mobile operators which support the image retrieval service may create inter-operator agreements to deliver the image retrieval message 110 across the multiple mobile operator networks at low cost or no cost. The present invention is not limited to a specific method for charging for the image retrieval application 30, the image retrieval service or delivery of the image retrieval message 110.

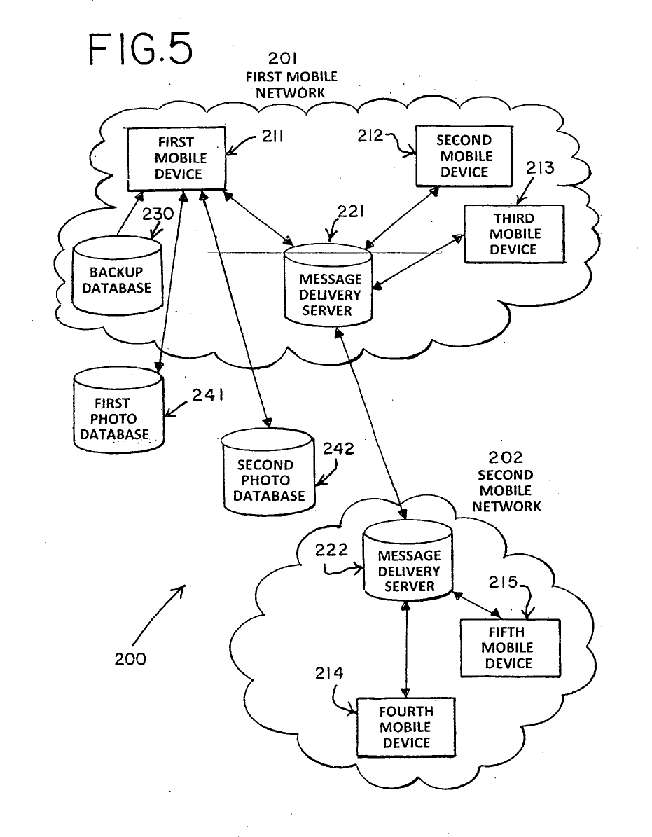

FIG. 5 generally illustrates a system 200 for requesting, retrieving and/or associating contact images on mobile devices in an embodiment of the present invention. A first mobile network operator and/or a second mobile network operator may serve the mobile devices. The first mobile network operator and/or the second mobile network operator may provide a first mobile network 201 and/or a second mobile network 202, respectively. A first mobile device 211, a second mobile device 212 and/or a third mobile device 213 may be subscribers of the first mobile network operator and/or may be connected to the first mobile network 201. A fourth mobile device 214 and/or a fifth mobile device 215 may be subscribers of the second mobile network operator and/or may be connected to the second mobile network 202.

In the embodiment depicted in FIG. 5, the first mobile device 211, the second mobile device 212 and/or the fourth mobile device 214 may be the mobile device 20 having the image retrieval application 30, and/or the third mobile device 213 and/or the fifth mobile device 215 may be the legacy mobile device 10 which lacks the image retrieval application 30. The present invention is not limited to the specific embodiment illustrated in FIG. 5.

The first mobile network operator, the first mobile network 201, the second mobile network operator and/or the second mobile network 202 may have additional subscribers and mobile devices not shown in FIG. 5. The system 200 may have additional mobile operators not shown in FIG. 5, and the mobile devices of each of the additional mobile operators may be legacy mobile devices 10 which lack the image retrieval application 30, mobile devices 20 which have the image retrieval application 30, or a combination of legacy mobile devices 10 which lack the image retrieval application 30 and mobile devices 20 which have the image retrieval application 30.

Mobile devices may be capable of roaming between mobile networks. For example, the first mobile device 211, the second mobile device 212, the third mobile device 213, the fourth mobile device 214 and/or the fifth mobile device 215 (collectively hereafter “the mobile devices 211-215”) may roam between the first mobile network 201 and the second mobile network 202. One having ordinary skill in the art will recognize that roaming will not interrupt and/or will not affect image retrieval if messaging agreements exist between mobile network operators, such as, for example, the first mobile network operator and the second mobile network operator. Request, retrieval and/or association of images using the image retrieval application 30 may merely require that the image retrieval request messages and the image retrieval response messages be deliverable between the mobile devices, such as, for example, the mobile devices 211-215.

The first mobile network operator and/or the first mobile network 201 may have a first message delivery server 221 and/or a backup database 230. The backup database 230 may be, for example, a PIM Data Backup Server and/or another database for storing data from the mobile devices, such as, for example, the first mobile device 211, the second mobile device 212 and/or the third mobile device 213. The backup database 230 may be accessible to the first mobile device 211. The second mobile network operator and/or the second mobile network 202 may have a second message delivery server 222.

One or more photo databases may be available and/or accessible to the mobile devices. For example, as generally illustrated in FIG. 5, a first photo database 241 and/or a second photo database 242 may be accessible to the first mobile device 211. The photo databases, such as, for example, the first photo database 241 and/or the second photo database 242, may be any databases capable of storing, organizing, presenting, and/or identifying images known to one having ordinary skill in the art. For example, the first photo database 241 and/or the second photo database 242 may be a server associated with an internet-based photo sharing website, such as, for example, Flickr, Photobucket and/or the like, and/or a social networking website, such as, for example, MySpace, Facebook and/or the like, which may associate an image with identifiable contact information.

Images stored in the photo databases, such as, for example, the first photo database 241 and/or the second photo database 242, may enable the first user to use an image in an image retrieval request message and/or an image retrieval response message without storing the image on the first mobile device 211. For example, the first user may designate that a profile picture in a Facebook account associated with the first user may be used as the attached image for image retrieval request messages and/or image retrieval response messages. Accordingly, the image retrieval application 30 and/or the first mobile device may create and/or send the image retrieval request messages and/or the image retrieval response messages with the attached image without storing the attached image on the first mobile device 211. The image retrieval application and/or the first mobile device 211 may retrieve the image stored in the photo databases, such as, for example, the first photo database 241 and/or the second photo database 242, whenever the image is needed for an image retrieval request message and/or an image retrieval response message.

Other mobile devices may have connections to and/or may access the backup database 230, the first photo database 241 and/or the second photo database 242. For example, other mobile devices of the first mobile network 201, such as, for example, the second mobile device 212 and/or the third mobile device 213, may have a connection to and/or may access the backup database 230. As another example, the mobile devices, such as, for example, the mobile devices 211-215, may have connections and/or may access the first photo database 241 and/or the second photo database 242 using an internet connection.

Users in the first mobile network 201 may use the backup database 230 to store information from the mobile devices of the users, such as, for example, the first mobile device 211, the second mobile device 212 and/or the third mobile device 213. For example, the users may use the backup database 230 to store images designated for various contact groups and/or categories, For example, the user of the first mobile device 211 may store a first image for business contacts, a second image for friends, and/or a third image for family members. With permission from a corresponding user, the first mobile network operator may make the images available for use by the mobile devices 20 having the image retrieval application 30 in the first mobile network 201, such as, for example, the first mobile device 211 and/or the second mobile device 212. Accordingly, if the second mobile device 212 is associated with one of the business contacts, the second mobile device 212 may obtain the first image from the backup database; if the second mobile device 212 is associated with one of the friends, the second mobile device 212 may obtain the second image from the backup database; and/or if the second mobile device 212 is associated with one of the family members, the second mobile device 212 may obtain the third image from the backup database.

With permission from the corresponding user, the first mobile network operator may publish the images to a public photo database, such as, for example, the first photo database 241 and/or the second photo database 242, accessible using the internet so that the mobile devices 20 having the image retrieval application 30 may obtain the images from the public photo database. The mobile device 20 having the image retrieval application 30 may query the public photo database, such as, for example, the first photo database 241 and/or the second photo database 242. For example, the mobile device 20 having the image retrieval application 30 may query the public photo database to obtain the images regardless of whether the mobile device 20 having the image retrieval application 30 subscribes to the first mobile operator or connects to the first mobile network 201.

User input on the first mobile device 211 may direct the image retrieval application 30 of the first mobile device 211 to attempt to retrieve images for one or more of the contact entries in the contacts database of the first mobile device 211. The user input may identify one of the contact entries, a selected subset of the contact entries, or all of the contact entries. Accordingly, the image retrieval application 30 may attempt to retrieve images for one of the contact entries, a selected subset of the contact entries, or all of the contact entries. In response, the image retrieval application 30 of the first mobile device 211 may send a query to the backup database 230 of the first mobile network 201. The query may have information about and/or identifiers for the contact entries for which the image retrieval application 30 requests the images. One or more of the images may have been previously uploaded to and/or stored in the backup database 230 of the first mobile network 201. In response to the query, the backup database 230 of the first mobile network operator may transmit the images which correspond to the contact entries to the first mobile device 211. After receiving the images which correspond to the contact entries, the image retrieval application 30 of the first mobile device 211 may associate the images the images which correspond to the contact entries with the contact entries in the contacts database of the first mobile device 211.

Then, the image retrieval application 30 of the first mobile device 211 may determine which of the images requested by the image retrieval application 30 were not available and/or were not provided by the backup database 230 of the first mobile network 201. The image retrieval application 30 may query one or more photo databases in an attempt to retrieve images corresponding to the contact entries for which the images requested by the image retrieval application 30 were not available and/or were not provided by the backup database 230. For example, the image retrieval application 30 may use the internet to send a query to a recipient photo database, such as, for example, the first photo database 221 and/or the second photo database 222. The query may use a known web-based query interface and/or application programming interface which may be associated with the recipient photo database.

After querying the photo databases, the image retrieval application 30 of the first mobile device 211 may determine which of the images requested by the image retrieval application 30 were not available and/or were not returned by the photo databases. For each contact entry for which the requested image was not available, the image retrieval application 30 of the first mobile device 211 may initiate the exchange of the image retrieval request messages and the image retrieval response messages described previously for FIG. 3. For example, referring again to FIG. 5, the image retrieval application 30 of the first mobile device 211 may create and/or may send image retrieval request messages to the second mobile device 212, the third mobile device 213, the fourth mobile device 214 and/or the fifth mobile device 215.

The image retrieval application 30 of the first mobile device 211 may not have information regarding a location, a mobile network operator and/or a mobile network corresponding to the second mobile device 212, the third mobile device 213, the fourth mobile device 214 and/or the fifth mobile device 215. The exchange of the image retrieval request messages and the image retrieval response messages may not require that the image retrieval application has information regarding the location, the mobile network operator and/or the mobile network corresponding to the second mobile device 212, the third mobile device 213, the fourth mobile device 214 and/or the fifth mobile device 215. The exchange of the image retrieval request messages and the image retrieval response messages may merely require that the image retrieval request messages and the image retrieval response messages be deliverable to the mobile devices 211-215.

The image retrieval application 30 of the first mobile device 211 may not have information regarding whether other mobile devices may be the legacy mobile device 10 which lacks the image retrieval application 30 or the mobile device 20 which has the image retrieval application 30. The image retrieval response messages and the exchange of the image retrieval request messages may not require information regarding whether other mobile devices may be the legacy mobile device 10 or the mobile device 20 having the image retrieval application 30. For example, as discussed previously, the image retrieval request messages and/or the image retrieval response messages may be formatted as standard messages which may have the human-readable instructions 118 and/or the retrieval automation parameters 120.

Therefore, the image retrieval request messages may be sent from the first mobile device 211 to the second mobile device 212 and/or the third mobile device 213 located in the first mobile network 201. The image retrieval request messages may be sent from the first mobile device 211 to the fourth mobile device 214 and/or the fifth mobile device 215 located in the second mobile network 202. The image retrieval request messages may travel through the first message delivery server 221, the second message delivery server 222 and/or additional servers not shown in FIG. 5.

The second mobile device 212 and/or the fourth mobile device 214 may have the image retrieval application 30. Therefore, the second mobile device 212 and/or the fourth mobile device 214 may automatically create an image retrieval response message. The third mobile device 213 and/or the fifth mobile device 215 may be the legacy mobile device 10 which lacks the image retrieval application 30. Therefore, the users of the third mobile device 213 and/or the fifth mobile device 215 may access, may view and/or may read the image retrieval request messages as standard messages using the messaging application 14 of the third mobile device 213 and/or the fifth mobile device 215, respectively. The users of the third mobile device 213 and/or the fifth mobile device 215 may manually reply to the image retrieval request messages by creating and/or sending image retrieval response messages to the first mobile device 211.

The image retrieval response messages sent from the second mobile device 212, the third mobile device 213, the fourth mobile device 214 and/or the fifth mobile device 215 may have images provided by the image retrieval application 30 and/or the users of the second mobile device 212, the third mobile device 213, the fourth mobile device 214 and/or the fifth mobile device 215, respectively. The image retrieval application 30 on the first mobile device 211 may receive and/or may process the image retrieval response messages. For example, the image retrieval application 30 on the first mobile device 211 may execute the “Save” function to save the images and/or to associate the images with the contact entries to which the images correspond.

One or more of the image retrieval request messages may not result in receipt of a corresponding image retrieval response message by the first mobile device 211 within a predetermined time period. Accordingly, the image retrieval application 30 on the first mobile device 211 may send one or more additional image retrieval request messages to the mobile devices which did not send an image retrieval response message to the first mobile device 211. The image retrieval application 30 on the first mobile device 211 may implement additional functions to record an error, to notify the user of the first mobile device 211 of successful or failed retrieval, to request instructions from the user of the first mobile device 211, and/or the like. Thus, the image retrieval application 30 on the first mobile device 211 may be capable of requesting, retrieving and/or associating images for multiple remote contacts in an automated fashion with minimal instruction and/or action from the user of the first mobile device 211.

A backup database, such as, for example, the backup database 230, and photo databases, such as, for example, the first photo database 241 and/or the second photo database 242, are not essential to the present invention. In an embodiment, the image retrieval application 30 of the first mobile device 211 may not have access to such databases and/or may not utilize such databases to request and retrieve images for association to the contacts database of the first mobile device 211. The first mobile device 211 may create and/or may send image retrieval request messages to other mobile devices, such as, for example, the second mobile device 212, the third mobile device 213, the fourth mobile device 214 and/or the fifth mobile device 215, without querying the backup database 230, the first photo database 241 or the second photo database 242.

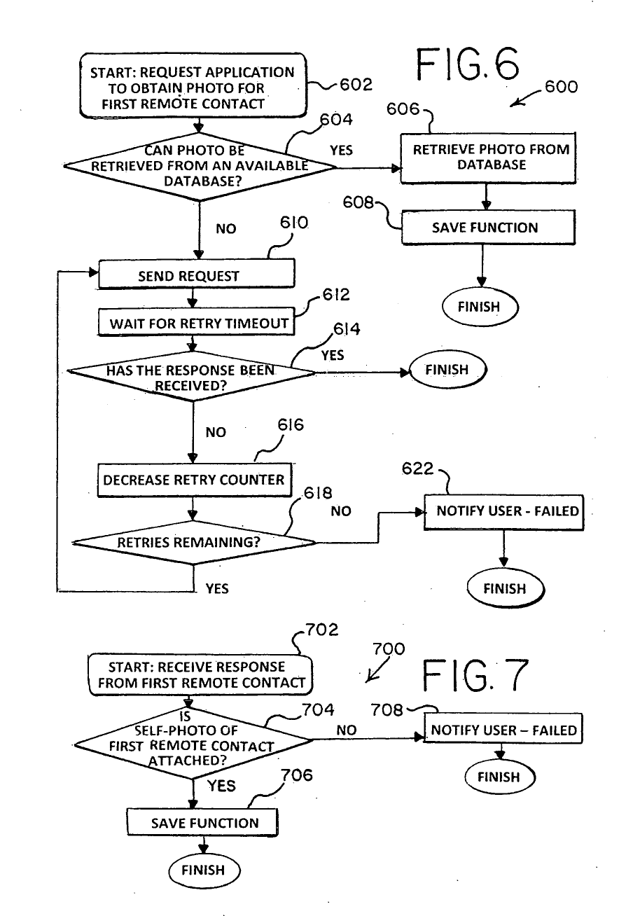

FIGS. 6-10 generally illustrate flowcharts of methods for requesting, retrieving and/or associating contact images on a mobile device in embodiments of the present invention. FIG. 6 generally illustrates a method 600 for requesting an image for a contact entry. For example, as shown in step 602, a local user of a first mobile device may direct the image retrieval application 30 on the mobile device to obtain an image for a first remote contact who may correspond to one of the contact entries in the contacts database on the first mobile device. The image may be, for example, a photograph of the first remote contact. In response, the image retrieval application 30 and/or the first mobile device may query available databases to determine whether the image for the first remote contact may be retrieved from one of the available databases, as shown in step 604. As shown in step 606, if the image for the first remote contact may be retrieved from one of the available databases, the image may be retrieved from the one of the available databases. As shown in step 608, the “Save” function may be executed as previously described.

As shown in step 610, if the image for the first remote contact cannot be retrieved from the available databases, the image retrieval application 30 and/or the first mobile device may send an image retrieval request message to the first remote contact. For example, the image retrieval application 30 and/or the first mobile device may send the image retrieval request message to a second mobile device associated with the first remote contact. Then, as shown in step 612, the image retrieval application 30 may start tracking time that lapses after sending the image retrieval request message, and/or the image retrieval application 30 may create, may configure and/or may start a “re-try” counter. The image retrieval application 30 may determine if the time that lapses after sending the image retrieval request message exceeds a predetermined threshold.

As shown in step 614, if the time that lapses after sending the image retrieval request message exceeds a predetermined time threshold, the image retrieval application 30 may determine whether a corresponding image retrieval response message was received. If the corresponding image retrieval response message was not received, the image retrieval application 30 may decrease the “re-try” counter by a value of one, as shown at step 616. As shown at step 618, the image retrieval application 30 may determine if sending additional image request messages is permissible. For example, the image retrieval application 30 may determine whether the “re-try” counter has been decreased to a value which is less than or equal to zero.

The time that lapses after sending the image retrieval request message may exceed the predetermined time threshold, the corresponding image retrieval response message may not be received, and sending additional image request messages may be permissible. Accordingly, the image retrieval application 30 and/or the first mobile device may send additional image retrieval request messages, as shown at step 620. In addition, the image retrieval application 30 may notify the local user that image retrieval failed as shown at step 622. The predetermined time threshold and/or the number of the additional image retrieval request messages may be determined by the image retrieval application 30 and/or may be configurable by the user.

For example, the predetermined threshold may be three days, and/or the number of additional image retrieval request messages may be two. Accordingly, the “re-try” counter may be initialized to two for transmittal of the image retrieval request message. If an image retrieval response message is not received by three days after transmittal of the image retrieval request message, the image retrieval application 30 may send a first additional image retrieval request message and/or may decrease the “re-try” counter by one to a value of one. If an image retrieval response message is not received by three days after transmittal of the first additional image retrieval request message, the image retrieval application 30 may send a second additional image retrieval request message and/or may decrease the “re-try” counter by one to a value of zero. If an image retrieval response message is not received by three days after transmittal of the second additional image retrieval request message, the image retrieval application 30 may notify the user that image retrieval failed.

FIG. 7 illustrates a method 700 for receiving and/or processing an incoming image retrieval response message corresponding to an earlier outgoing image retrieval request message. The first mobile device may have the image retrieval application 30 and/or a contact entry in the contacts database which corresponds to a first remote contact. The earlier outgoing image retrieval request message may have been transmitted from the first mobile device to the first remote contact.

As shown in step 702, the first mobile device may receive the incoming image retrieval response message responsive to the earlier outgoing image retrieval request message. After receiving the incoming image retrieval response message, the image retrieval application 30 and/or the first mobile device may parse the incoming image retrieval response message. For example, the image retrieval application 30 and/or the first mobile device may associate the image retrieval response message with the earlier outgoing image retrieval request message. As a further example, the image retrieval application 30 and/or the first mobile device may identify that the first remote contact sent the incoming image retrieval response message. As shown in step 704, the image retrieval application 30 may determine whether the incoming image retrieval response message provides an image for the first remote contact, such as, for example, a photograph of the first remote contact.

As shown in step 706, if the incoming image retrieval response message provides the image, the image retrieval application 30 and/or the first mobile device may execute the “Save” function as described previously. As shown in step 708, if the incoming image retrieval response message does not provide the image, the image retrieval application 30 and/or the first mobile device may notify the first user that image retrieval failed.

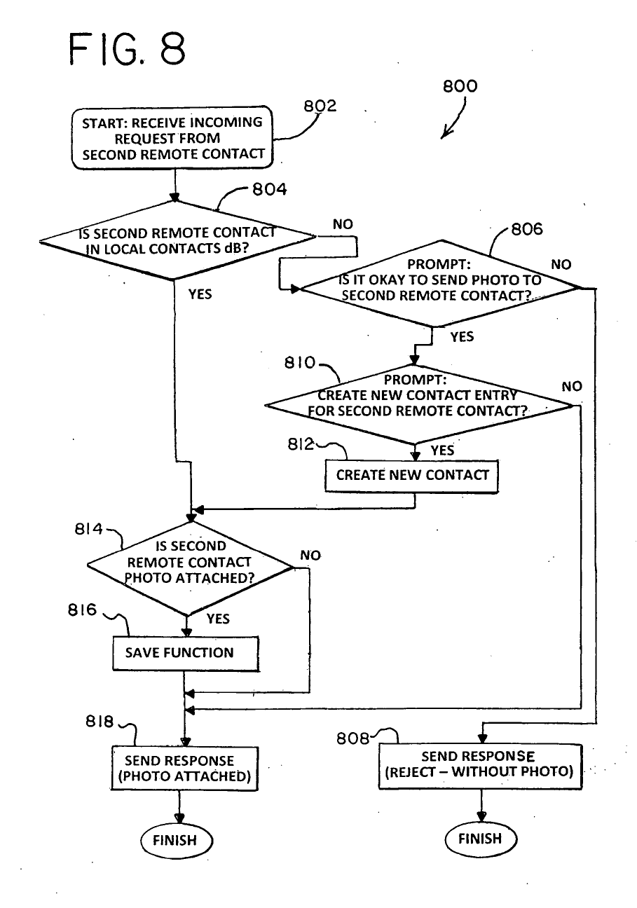

FIG. 8 generally illustrates a method 800 for receiving and/or processing an incoming image retrieval request message from a third mobile device of a second remote contact. As shown in step 802, the first mobile device and/or the local user associated with the first mobile device may receive the incoming image retrieval request message. As shown in step 804, the image retrieval application 30 on the first mobile device may determine whether the second remote user corresponds to a contact entry in the contacts database on the first mobile device. As shown in step 818, if the second remote user corresponds to a contact entry in the contacts database on the first mobile device, the image retrieval application 30 may automatically create and/or send an image retrieval response message providing an image for the local user, such as, for example, a photograph of the local user.

As shown in step 806, if the second remote user does not correspond to a contact entry in the contacts database on the first mobile device, the image retrieval application 30 may direct the first mobile device to query the local user whether to send the image associated with the local user to the second remote contact. As shown in step 808, if the local user directs the image retrieval application 30 to not send the image associated with the local user to the second remote contact, the image retrieval application 30 and/or the first mobile device may send an image retrieval response message which does not provide the image associated with the local user. The image retrieval response message which does not provide the image may indicate rejection of the image retrieval request message. Alternatively, if the local user directs the image retrieval application 30 to not send the image associated with the local user to the second remote contact, the image retrieval application 30 and/or the first mobile device may not send an image retrieval response message to the second remote contact.

As shown in step 818, if the local user directs the image retrieval application 30 to send the image associated with the local user to the second remote contact, the image retrieval application 30 and/or the first mobile device may send an image retrieval response message providing the image associated with the local user. As shown at step 810, if the second remote user does not correspond to a contact entry in the contacts database on the first mobile device, the image retrieval application 30 may direct the first mobile device to query the local user whether to create a new contact entry for the second remote contact in the contacts database of the first mobile device. As shown at step 812, if the local user directs the first mobile device and/or the image retrieval application to create a new contact entry for the second remote contact, then the image retrieval application 30 and/or the first mobile device may create the new contact entry for the second remote contact. For example, the image retrieval application 30 and/or the first mobile device may create the new contact entry directly using the contacts database stored in the storage module 12 of the first mobile device. As another example, the image retrieval application 30 may send a request to create the new contacts entry to the contacts application 14 on the first mobile device. In either case, the image retrieval application 30 and/or the first mobile device may utilize information about the second remote contact provided by the image retrieval request message. For example, the sender address 114 and/or the sender information 124 may be used to create the new contacts entry for the second remote contact.

As shown at step 814, the image retrieval application 30 may determine whether the image retrieval request message provided an image associated with the second remote contact, such as, for example, a photograph of the second remote contact. As shown at step 816, if the image retrieval request message provided an image associated with the second remote contact, the image retrieval application 30 may execute the “save” function described previously.

As shown at step 818, the image retrieval application 30 and/or the first mobile device may send an image retrieval response message providing the image associated with the local user to the third mobile device and/or the second remote contact. If the image retrieval application 30 and/or the first mobile device sends an image retrieval response message providing the image associated with the local user, the image retrieval application 30 and/or the first mobile device may utilize a default photo previously defined by the local user for responding to image retrieval request messages. If the second remote contact corresponds to a contacts entry in the contacts database of the first mobile device and the local user has assigned the contacts entry of the second remote contact to a contacts group and/or category, the image retrieval application 30 may utilize a default photo previously defined by the local user for sending to contact entries in the contacts group and/or category. Alternatively, the image retrieval application 30 may direct the first mobile device to prompt the local user to select an image to send to the second remote contact with the image retrieval response message.

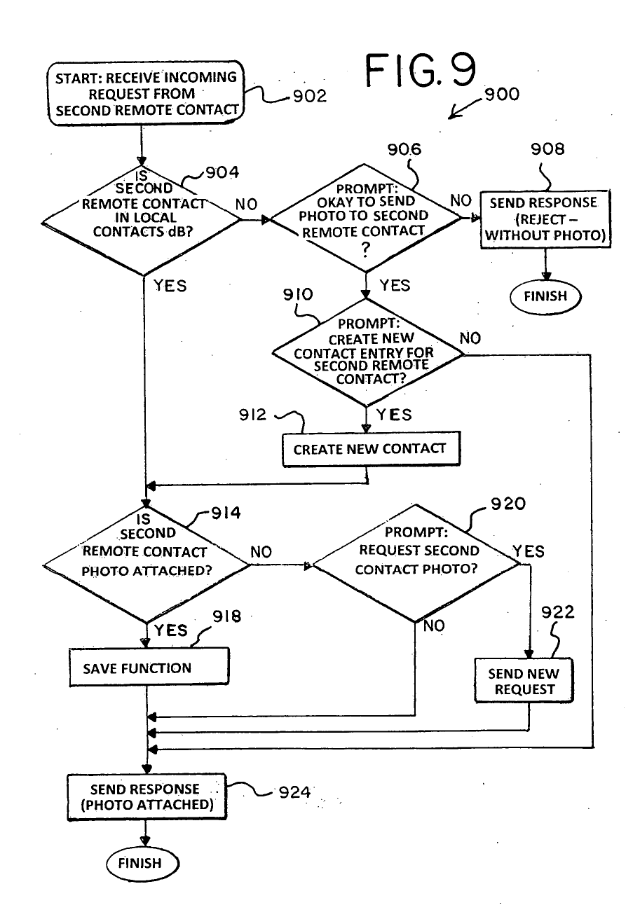

FIG. 9 generally illustrates a method 900 for receiving and/or processing an incoming image retrieval request message from the third mobile device of the second remote contact. As shown in step 902, the first mobile device and/or the local user associated with the first mobile device may receive the incoming image retrieval request message. As shown in step 904, the image retrieval application 30 on the first mobile device may determine whether the second remote contact corresponds to a contact entry in the contacts database on the first mobile device. As shown in step 924, if the second remote contact corresponds to a contact entry in the contacts database on the first mobile device, the image retrieval application 30 may automatically create and/or send an image retrieval response message providing an image for the local user, such as, for example, a photograph of the local user.

As shown in step 906, if the second remote contact does not correspond to a contact entry in the contacts database on the first mobile device, the image retrieval application 30 and/or the first mobile device may query the local user whether to send the image associated with the local user to the second remote contact. As shown in step 924, if the local user directs the image retrieval application 30 to send the image associated with the local user to the second remote contact, the image retrieval application 30 may direct the first mobile device to send an image retrieval response message providing the image associated with the local user.

As shown in step 908, if the local user directs the image retrieval application 30 to not send the image associated with the local user to the second remote contact, the image retrieval application 30 may direct the first mobile device to send an image retrieval response message which does not provide the image associated with the local user. The image retrieval response message which does not provide the image may indicate rejection of the image retrieval request message. Alternatively, if the local user directs the image retrieval application 30 to not send the image associated with the local user to the second remote contact, the image retrieval application 30 and/or the first mobile device may not send an image retrieval response message to the second remote contact.

As shown at step 910, if the second remote user does not correspond to a contact entry in the contacts database on the first mobile device, the image retrieval application 30 may direct the first mobile device to query the local user whether to create a new contact entry for the second remote contact in the contacts database of the first mobile device. As shown at step 912, if the local user directs the first mobile device and/or the image retrieval application to create a new contact entry for the second remote contact, then the image retrieval application 30 and/or the first mobile device may create the new contact entry for the second remote contact. For example, the image retrieval application 30 and/or the first mobile device may create the new contact entry directly using the contacts database as stored in the storage module 12 of the first mobile device. As another example, the image retrieval application 30 may send a request to create the new contacts entry to the contacts application 14 on the first mobile device. In either case, the image retrieval application 30 and/or the first mobile device may utilize information about the second remote contact from the image retrieval request message. For example, the sender address 114 and/or the sender information 124 may be used to create the new contacts entry for the second remote contact.

As shown at step 914, the image retrieval application 30 may determine whether the image retrieval request message provided an image associated with the second remote contact, such as, for example, a photograph of the second remote contact. As shown at step 918, if the image retrieval request message provided an image associated with the second remote contact, the image retrieval application 30 may execute the “save” function described previously.

As shown at step 920, if the image retrieval request message did not provide an image associated with the second remote contact, the image retrieval application 30 may direct the first mobile device to query the local user whether to request an image from the second remote contact, such as, for example, a photograph of the second remote contact. As shown at step 922, if the local user directs the image retrieval application 30 and/or the first mobile device to request an image from the second remote contact, the image retrieval application 30 and/or the first mobile device may transmit an outgoing image retrieval request message to the second remote contact. If the local user directs the image retrieval application 30 and/or the first mobile device to not request an image from the second remote contact, the image retrieval application 30 and/or the first mobile device may not transmit an outgoing image retrieval request message to the second remote contact.

In an embodiment, the image retrieval application 30 may determine whether the contacts entry corresponding to the second remote contact in the local contacts database has an image for the second remote contact. If the contacts entry corresponding to the second remote contact has an image for the second remote contact, the image retrieval application 30 and/or the first mobile device may not query the local user whether to request an image from the second remote contact and/or may not generate and/or send the outgoing image retrieval request message.

As shown at step 924, the image retrieval application 30 and/or the first mobile device may send an image retrieval response message providing the image associated with the local user to the third mobile device and/or the second remote contact. If the image retrieval application 30 and/or the first mobile device sends an image retrieval response message providing the image associated with the local user, the image retrieval application 30 and/or the first mobile device may utilize a default photo previously defined by the local user for responding to image retrieval request messages. If the second remote contact corresponds to a contacts entry in the contacts database of the first mobile device and the local user has assigned the contacts entry of the second remote contact to a contacts group and/or category, the image retrieval application 30 may utilize a default photo previously defined by the local user for sending to contact entries in the contacts group and/or category. Alternatively, the image retrieval application 30 may direct the first mobile device to prompt the local user to select an image to send to the second remote contact with the image retrieval response message.

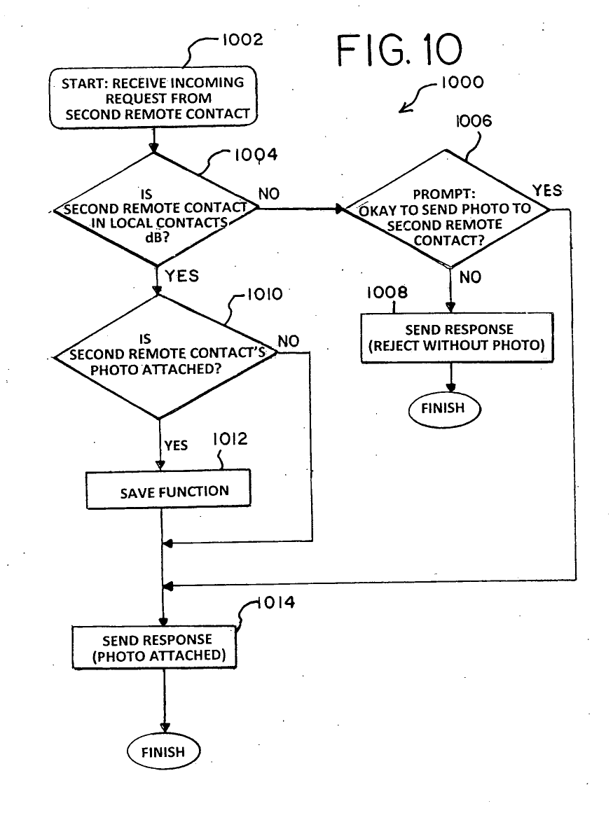

FIG. 10 generally illustrates a method 1000 for receiving and/or processing an incoming image retrieval request message from a third mobile device of a second remote contact. As shown in step 1002, the first mobile device may receive the incoming image retrieval request message from the second remote contact. As shown in step 1004, the image retrieval application 30 on the first mobile device may determine whether the second remote contact corresponds to a contact entry in the contacts database on the first mobile device. As shown in step 1014, if the second remote contact corresponds to a contact entry in the contacts database on the first mobile device, the image retrieval application 30 may automatically create and/or send an image retrieval response message providing an image for the local user, such as, for example, a photograph of the local user.

As shown in step 1006, if the second remote user does not correspond to a contact entry in the contacts database on the first mobile device, the image retrieval application 30 may direct the first mobile device to query the local user whether to send the image associated with the local user to the second remote contact. As shown in step 1014, if the local user directs the image retrieval application 30 to send the image associated with the local user to the second remote contact, the image retrieval application 30 may direct the first mobile device to send an image retrieval response message providing the image associated with the local user.

As shown in step 1008, if the local user directs the image retrieval application 30 to not send the image associated with the local user to the second remote contact, the image retrieval application 30 may direct the first mobile device to send an image retrieval response message which does not provide the image associated with the local user. The image retrieval response message which does not provide the image may indicate rejection of the image retrieval request message. Alternatively, if the local user directs the image retrieval application 30 to not send the image associated with the local user to the second remote contact, the image retrieval application 30 and/or the first mobile device may not send an image retrieval response message to the second remote contact.

As shown at step 1010, if the second remote user corresponds to a contact entry in the contacts database on the first mobile device, the image retrieval application 30 may determine whether the image retrieval request message provided an image associated with the second remote contact, such as, for example, a photograph of the second remote contact. As shown at step 1012, if the image retrieval request message provided an image associated with the second remote contact, the image retrieval application 30 may execute the “save” function described previously.

As shown at step 1014, the image retrieval application 30 and/or the first mobile device may send an image retrieval response message providing the image associated with the local user to the third mobile device and/or the second remote contact. If the image retrieval application 30 and/or the first mobile device sends an image retrieval response message providing the image associated with the local user, the image retrieval application 30 and/or the first mobile device may utilize a default photo previously defined by the local user for responding to image retrieval request messages. If the second remote contact corresponds to a contacts entry in the contacts database of the first mobile device and the local user has assigned the contacts entry of the second remote contact to a contacts group and/or category, the image retrieval application 30 may utilize a default photo previously defined by the local user for sending to contact entries in the contacts group and/or category. Alternatively, the image retrieval application 30 may direct the first mobile device to prompt the local user to select an image to send to the second remote contact with the image retrieval response message.

It should be understood that various changes and modifications to the presently preferred embodiments described herein will be apparent to those skilled in the art. Such changes and modifications may be made without departing from the spirit and scope of the present invention and without diminishing its attendant advantages.

We claim:

1. A method for retrieving contact images for a user of a first mobile device having contact entries stored in an internal contacts database, the method comprising the steps of:
accepting user input on the first mobile device wherein the user input identifies a first contact entry of the contact entries;
determining if a photo database accessible to the first mobile device and remotely located relative to the first mobile device provides a first contact image corresponding to the first contact entry wherein the first mobile device determines if the photo database provides the first contact image;
receiving the first image on the first mobile device from the photo database if the photo database provides the first contact image;
associating the first contact image with the first contact entry in the internal contacts database if the first contact image is received from the photo database wherein the first mobile device automatically associates the first contact image with the first contact entry without input from the user directing the first mobile device to associate the first contact image with the first contact entry; and
transmitting a first request message from the first mobile device to a second mobile device if the photo database'does not provide the first contact image wherein the second mobile device is associated with the first contact entry.

2. The method of claim 1 further comprising the step of:
receiving a response message providing the first contact image from the second mobile device wherein the first mobile device automatically associates the first contact image provided by the response message with the first contact entry in the internal contacts database without input from the user directing the first mobile device to associate the first contact image with the first contact entry.

3. The method of claim 1 further comprising the step of:
transmitting a second request message to the second mobile device if a response to the first request message is not received during a predetermined time period.

4. The method of claim 1 further comprising the steps of:
identifying a second contact entry which is a different entry than the first contact entry based on the user input; and
determining if the photo database provides a second contact image associated with the second contact entry which is a different image than the first contact image wherein the first mobile device determines if the photo database provides the first contact image and the second contact image substantially simultaneously.

5. The method of claim 1 further comprising the step of:
attaching a second contact image to the first request message wherein the second contact image is associated with the user of the first mobile device and further wherein the first mobile device sends the second contact image to the second mobile device with the first request message.

6. The method of claim 1 further comprising the step of:
receiving a response message providing the first contact image from the second mobile device wherein the response message has an identifier copied into the response message from the first request message wherein the first mobile device uses the identifier to determine that the response message corresponds to the first request message.

7. A system for exchanging contact images, the system comprising:
a mobile device having contact entries stored in a contacts database of the mobile device wherein each of the contact entries is associated with a remote contact;
an application executed by the mobile device; and
a first request message from a first sender received by the mobile device wherein the application determines if the first sender corresponds to one of the contact entries and further wherein the application determines if the first request message provides a first contact image wherein the application automatically stores the first contact image in the mobile device in association with the one of the contact entries if the first sender corresponds to the one of the contact entries and the first request message provides the first contact image.

8. The system of claim 7 further comprising:
a response message automatically transmitted with a second contact image associated with a user of the mobile device if the first sender corresponds to one of the contact entries wherein the mobile device transmits the response message and the second contact image to the first sender without input from the user directing the mobile device to send the response message with the second contact image.

9. The system of claim 7 further comprising:
a response message with a second contact image associated with a user of the mobile device transmitted from the mobile device to the first sender wherein the user of the mobile device generates the response message using a messaging application executed by the mobile device and further wherein the response message has an identifier copied from the first request message.

10. The system of claim 7 further comprising:
a hyperlink in the first request message wherein selection of the hyperlink by a user of the mobile device provides a web page which enables the user of the mobile device to provide a second contact image associated with the user of the mobile device which is accessible to the first sender.

11. The system of claim 7 further comprising:
a subset of the contact entries specified by a user of the mobile device before receipt of the first request message wherein the application automatically directs the mobile device to send a response message to the first sender providing a second contact image associated with the user of the mobile device in response to the first request message if the first sender corresponds to one of the subset.

12. The system of claim 7 further comprising:
a response message automatically transmitted from the mobile device to the first sender if the first sender does not correspond to any of the contact entries wherein the response message indicates that the first request message was rejected.

13. The system of claim 7 further comprising:
a new contact entry created by the application in response to the first request message if the first sender does not correspond to any of the contact entries wherein the application uses information regarding the first sender which is provided by the request message to create the new contact entry and further wherein the mobile device stores the new contact entry in the contacts database.

14. The system of claim 7 further comprising:
a first response message transmitted with a second contact image associated with a user of the mobile device wherein the application directs the mobile device to transmit the first response message to the first sender in response to the first request message;
a second request message from a second sender received by the mobile device after the receipt of the first request message; and
a second response message transmitted with a third contact image associated with the user of the mobile device wherein the application directs the mobile device to transmit the second response message to the second sender in response to the second request message and further wherein the third contact image is a different image than the second contact image wherein the second contact image and the third contact images are specified by the user before the mobile device received the first request message.

15. The system of claim 7 further comprising:
a response message transmitted from the mobile device to the first sender wherein the application directs the mobile device to retrieve a second contact image associated with a user of the mobile device from a photo database located remotely relative to the mobile device in response to the first request message and further wherein the response message provides the second contact image to the first sender.

16. A method for retrieving contact images for a user of a first mobile device having a contact entry stored in a contacts database, the method comprising the steps of:
generating a request message wherein the first mobile device generates the request message based on the contact entry;
transmitting the request message from the first mobile device to a first electronic address associated with a second mobile device corresponding to the contact entry; and
determining if incoming messages received by the first mobile device correspond to the request message wherein the first mobile device determines if a first incoming message provides a first contact image if the first incoming message corresponds to the request message and further wherein the first mobile device automatically stores the first contact image in association with the contact entry if the first incoming message corresponds to the request message and provides the first contact image.

17. The method of claim 16 further comprising the step of:
selecting a second contact image stored by the first mobile device wherein the second contact image is selected by user input on the first mobile device and further wherein selection of the second contact image associates the second contact image with the user of the first mobile device wherein the second contact image is transmitted with the request message from the first mobile device to the second mobile device in response to the selection of the second contact image.

18. The method of claim 16 further comprising the step of:
determining an amount of time which elapsed after the first mobile device stored a second contact image which is associated with the contact entry in the contacts database wherein the first mobile device sends the request message in response to determination by the first mobile device that the amount of time which elapsed after the first mobile device stored the second contact image exceeds a predetermined threshold.

19. The method of claim 16 further comprising the step of:
selecting a set of one or more contact entries from the contacts database wherein the user of the first mobile device selects the set of one or more contacts entries using the first mobile device and further wherein the request message is generated in response to selection of the set of one or more contact entries by the user of the first mobile device.

20. The method of claim 16 further comprising the step of:
transmitting a second request message from the first mobile device to a second electronic address associated with the contact entry which is a different electronic address than the first electronic address wherein the first mobile device automatically sends the second request message without input from the user directing the first mobile device to send the second request message.
